(19) United States
(12) Patent Application Publication
(10) Pub. No.: US 2013/0191287 A1
(43) Pub. Date: Jul. 25, 2013

(54) VIDEOCONFERENCE ACCESS FACILITY

(71) Applicants: Albert F Gainer, III, Nashville, TN (US); Paul Van Hoesen, Nashville, TN (US); Richard Chambers, Nashville, TN (US); Marc Kunkel, Nashville, TN (US); Michael Kunkel, Nashville, TN (US)

(72) Inventors: Albert F Gainer, III, Nashville, TN (US); Paul Van Hoesen, Nashville, TN (US); Richard Chambers, Nashville, TN (US); Marc Kunkel, Nashville, TN (US); Michael Kunkel, Nashville, TN (US)

(73) Assignee: VTM, LLC, Nashville, TN (US)

(21) Appl. No.: 13/877,070

(22) PCT Filed: Oct. 1, 2011
(86) PCT No.: PCT/US11/54477

§ 371 Date: Mar. 29, 2013

Related U.S. Application Data
(60) Provisional application No. 61/388,987, filed on Oct. 1, 2010.

(51) Int. Cl. G06Q 20/10

(52) U.S. Cl. CPC G06Q 20/10
USPC 705/44

(57) ABSTRACT

A videoconference access facility is described that allows people to obtain services and engage in financial transactions via a face-to-face video conference with a remote moderator. Because the remote moderator is there to receive verbal instructions and provide verbal support, the facility allows people to engage in complex transactions even if they are unable to read or write. The facility can be equipped with numerous types of devices that allow the moderator to view and receive information from documents, financial instruments, identification cards, and smart cards; as a result, the facility can provide financial transactions without the support of a bank. The facility may be used as part of a greater telecommunication network to deliver such services.

### CROSS-REFERENCE TO RELATED APPLICATIONS

This application cites for priority to provisional U.S. Application 61/388,987, filed on Oct. 1, 2011, and which is currently pending. U.S. Application 61/388,987 is hereby incorporated by reference in its entirety into the instant application.

### BACKGROUND

The present disclosure relates generally to telecommunications-mediated transactions and services, including financial transactions that do and do not involve the use of bank accounts. Devices, networks, systems, and methods for such transactions are provided.

An estimated 40 million households (106 million residents), or nearly a third of the U.S. population, are “unbanked” or “underbanked.” The number is much larger worldwide. They either have no bank accounts or cannot use their bank accounts for a significant fraction of their transactions. This may be true for many reasons; for example, a person who receives a weekly paycheck must often pay bills immediately upon receiving the paycheck, and does not have time to wait for a bank to clear the check and then to wait while the postal system delivers the check to a creditor. Many of those people who have bank accounts do not have the skills (such as functional literacy, language skills, and technical computer skills) to access to take advantage of internet banking services, and so their ability to conduct transactions away from the bricks-and-mortar bank is limited. Under-banked or unbanked people must rely on cash, money orders, and other non-bank mediated instruments.

Such persons face serious hardships in meeting their financial needs. Most creditors expect payment by paper check. Although many major creditors, such as utilities and government agencies, maintain a payment window that will accept cash or money orders, the payment windows are only open during certain times, typically weekday business hours. It is difficult or impossible for fully employed people to appear at these windows while they are open. In addition, absent an account, banks and many alternative financial service providers will not extend credit.

An additional concern is that recent immigrants often cannot speak the local language of the country in which they reside. The anxiety transacting important business in a language other than one's native language discourages many immigrants from obtaining needed financial services; standard service delivery models rarely address this issue.

Great advances have been made in terms of online systems available to computer users, facilitating rapid payment of creditors from bank funds or credit cards. Such transactions do not have the lag time associated with paper mail. If paychecks are direct-deposited, creditors can be paid on the same day the paycheck is issued. However, these systems are only usable by people who own computers, have immediately available funds or ready credit, who are literate, who are comfortable transacting business via computer, and who have either a bank account or a credit card (or both). A significant fraction of the population does not meet one or more of these requirements.

The same barriers exist for using automatic teller machines (ATM). ATMs are designed for servicing the needs of bank or credit account holders either through self-service or visual or audio-visual assisted transaction services (a teller “call” function). These systems allow a bank account holder who is familiar with banking technology to transact business in a automated method. Banking ATM systems are not designed to interface into the types of systems required to provide immediate funds to the unbanked, or to provide the other third party services sought by the unbanked such as bill payment, short term loans, or other services. ATM systems are not typically designed with the needs of the unbanked population, particularly people with language or literacy barriers.

Bricks-and-mortar businesses exist to serve this group of people; this industry is referred to as the “alternative financial services” industry. One example is the check-cashing store, in which a live moderator receives a check, verifies the identity of the payee, and dispenses cash on the check in return for a transaction fee. Another example is the short-term lender, who provides a small, short-term loan, generally upon verification of employment and the submission of collateral in the form of a check drawn on a verified bank account; again, these loans are provided by a live moderator in a bricks-and-mortar shop. The requirement for the check as collateral of course requires that the customer has a checking account. Many alternative financial service businesses, such as check cashing shops, sell money orders and prepaid cards (such as debit cards, gift cards, and calling cards). Others provide “payment transfers,” in which a person provides payment at one bricks-and-mortar shop for delivery to a person at another bricks-and-mortar shop (prominent examples of providers of this service include MoneyGram and Western Union).

A few large retail chains provide limited check-cashing, bill pay, and payment transfer services. Due the inherent risk and complications inherent in some alternative financial services transactions, these chains limit the size and types of transactions they will accept to only the safest instruments (such as printed payroll checks from known companies)

The provision of non-bank financial services at bricks-and-mortar stores solves the problem of delivering services to people who cannot or will not transact business via computer. However, bricks-and-mortar stores have the disadvantages of limited hours, few locations, and high operating costs. Such costs inevitably are passed on to the customer, who can ill afford them.

Consequently, there is a long-felt and unmet need for a means to provide, low cost, face-to-face financial services without a brick-and-mortar establishment that can be used by unbanked people regardless of their lingual, technological, and literacy capabilities.

Similarly, there are a wide variety of public services that are relatively inaccessible due to the need to present one's self and one's documentation at a governmental office. Governmental offices are expensive to procure, expensive to maintain, and notoriously understaffed, leading to long delays in service. Like many establishments, governmental offices are typically open when most people are at work. Typically documentation and positive identification are presented and a service is transacted requiring payment. Rural constituents may be negatively affected by a lack of government office facilities; rural regions often have higher than usual unbanked or under-banked populations. In Tennessee, USA, for example, 30 of 95 counties in the state do not have a location to renew a driver's license due to the high per-transaction cost of operating a traditional bricks-and-mortar location. This service requires face-to-face service interaction, document verification, issuance of a new driver's license card or sticker, and the payment for services. Like financial service providers, many governmental entities offer services online via the Internet, but these suffer from the same limitations described above for online financial services. Consequently, there is a long-felt and unmet need for a means to establish one's eligibility for public services without the need to be present at a bricks-and-mortar office, access to the Internet, a bank account, ready credit, specific language skills, literacy, or computer skills.

### SUMMARY

The following presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented below.

There is a long-felt but unmet need in the art for a system that can replicate the service advantages of a face-to-face transaction that allows automated bank and non-bank mediated transactions at low cost and available at any time. Such a system should allow the user to conduct various necessary financial transactions, such as cashing a check, cashing a money order, buying a money order, paying a creditor, obtaining credit, buying a pre-paid card, and making a payment transfer to another individual. Such a system should provide for the reliable establishment of the user's identity and validation of any form of payment (such as cash, checks, debit cards, and money orders). There is a similar need for a system that has the advantages of a face-to-face transaction to allow automated establishment of a person's qualifications for public services and to allow automated establishment of a person's qualifications and the issuance of appropriate government documentation. This will advantageously be accomplished without a local moderator, but rather using a telecommunications link to a moderator remote from the user. The moderator may be located, for example, in a centralized call center. Great advantages can be realized if the system allows live interaction with a human moderator who can help the user complete the financial transaction at every step in the process. Further advantages can be realized if the system can be utilized by a user who cannot read or write. Further advantages can be realized if the system can be utilized by a user regardless of the user's native language. Additional advantages can be realized if the system, once implemented, can be utilized by multiple service providers, to allow a broad array of services to be offered at a given location (although it is contemplated that the system will comprise thousands of automated locations).

These needs and others can be met by some of the various embodiments of the facilities, methods, and systems disclosed herein, although it is to be understood that not every embodiment will fulfill all of the needs described above.

The disclosure provides a videoconference access facility (sometimes referred to in this disclosure as a “videoconferencing facility”). A general embodiment of the facility comprises a means for identifying a user electronically, a means for teleconferencing between the user and a moderator, a means for creating a payment instrument, and a means for transmitting and receiving data between the user and the moderator. Another general embodiment of the facility comprises a communications interface linking the facility to a remote moderator over a telecommunications network; a videoconference display area; a data display area; a primary camera positioned to capture an image of the user's face; a primary microphone capable of capturing voice-quality sound; a primary speaker capable of producing voice-quality sound; a plurality of secure enclosures extending to the front of the facility capable of interchangeably containing a peripheral device, and comprising an interchangeable front panel to provide partial access to the peripheral device by the user; an identity reader to transmit identity data to a remote moderator, located in one of the said enclosures, wherein the identity reader is selected from the group consisting of: an identity card reader, a signature pad, a fingerprint reader, a barcode scanner, and a document scanner; and a computing device connected to the communications interface and configured to exchange data with the videoconference display area, the data display area, the primary camera, the primary microphone, the primary speaker, and the identity reader. Further embodiments comprise an audiovisual recording device to maintain a full record of each transaction.

The facility may comprise additional devices and structures as described below. In some cases, certain structures listed above may be omitted. The facility serves to allow immediate verbal communication between the moderator and the user, rapidly collect all information about the user and the transaction, transmit the information to the moderator, and receive instructions from the moderator (such as an instruction to dispense cash to the user). Because the moderator works in a remote location, a single moderator can operate numerous facilities simultaneously. Moderators can be used in more than one location, such that the moderator for a given facility is always working during normal business hours at the moderator's location, regardless of the hour at the facility's location. This will improve the working conditions of the moderator, in addition to providing round-the-clock service to the facility.

A method of performing a remote service via a videoconference access facility is provided. Some embodiments are methods of providing a verbally-mediated service to a user from a plurality of available services via a videoconference, without reference to or requirement for a bank account of the user. Some such embodiments comprise: establishing a videoconference with the user of a videoconference access facility via a telecommunications network; receiving a request for the service from the user via the videoconferencing facility; receiving identifying information from the user via the videoconferencing facility, said identifying information comprising an image of the user's face captured by the videoconferencing facility; transmitting the user's identity to a service-provider computing system; receiving service-related content from the service-provider computing system; and transmitting the service-related content to the user over the network. Other such embodiments comprise: establishing a videoconference with a remote moderator from a videoconferencing facility via a telecommunications network; transmitting a request for the service from the user via the videoconferencing facility; transmitting identifying information from the user via the videoconferencing facility to the remote moderator, said identifying information comprising an image of the user's face captured by the videoconferencing facility; receiving service-related content from the remote moderator and providing the content to the user.

Some embodiments of the method are methods of transmitting payment on behalf of a user of a videoconference access facility without a requirement for, or reference to the user's bank account, comprising: establishing the identity of the user by a process comprising (i) receiving from the user a code corresponding to a money transfer, or capturing an image of the user's face with a camera and transmitting the image to a remote moderator; and (ii) receiving identifying information with an identity document reader to corroborate the user's identity, and transmitting the identifying information to the remote moderator; establishing the availability of funds; and transmitting payment to the user or a third party.

In some embodiments the user's identity is established by transmitting an image of the user's face (or other identifying physical feature, such as thumbprint) to the moderator, reading an identification document, and verifying that the user's face corresponds to the user's purported identity (or a combination of the foregoing). One embodiment of the identification document is a membership card specific for the organization maintaining the facility. In some embodiments of the method the availability of the funds is established by issuing credit to the user, by receiving cash at the financial facility, by receiving a paper financial instrument that is scanned and verified, and by verifying that the user is the intended recipient of a money transfer (or a combination of the foregoing). In some embodiments of the method payment is transmitted by instructing the facility to dispense cash to the user, by instructing the facility to print a money order, by instructing the facility to write value to a prepaid card, by transmitting electronic payment to a third party, and by requesting a payment transfer to another individual (or a combination of the foregoing). Some embodiments of the method comprise recording the voice dialog and the user's image during the transaction and saving the dialog and images to a secondary storage audiovisual recorder, thus creating a durable record of the transaction.

A method is provided of establishing eligibility for public services via a videoconference access facility, comprising establishing the identity of the user at the facility, evaluating the availability public services for the user, and transmitting payment or official documentation as necessary.

A remote services telecommunications network is provided, comprising: a videoconference access facility as described above; a remote moderator workstation connected to the facility via one or more datalinks configured to transmit voice data in both directions, video data at least from the facility to the remote moderator workstation, and configured to transmit instructions from the moderator workstation to the facility; a database server that is accessible by the moderator workstation, and which contains a database of user identity information; and a telecommunications link capable of exchanging data between the moderator workstation and an external service provider system. Some embodiments of the network may comprise additional components, such as a record file server on which is recorded at least audiovisual records of the transactions performed at the facility. Some embodiments of the network may also comprise reporting software capable of providing an accounting of all transactions or all transactions of a certain category (user, financial service provider involved in the transaction, type of financial instrument involved in the transaction, location of the facility, remote moderator involved, etc.)

A workstation for a remote moderator is provided, comprising: a remote feed display that is transparent when viewed from the side opposite the moderator; a local data display area; a workstation camera positioned on the side of the remote feed display opposite the moderator and positioned to capture an image of the moderator's face; a workstation microphone positioned to capture the moderator's voice; a connection to a videoconference access facility via a telecommunications network; a connection to at least one of a database server and an applications server; and a computing device connected to the videoconference access facility and configured to exchange data with the videoconferencing facility.

### BRIEF DESCRIPTION OF THE DRAWINGS AND APPENDIXES

FIG. 1: An exemplary embodiment of the videoconference access facility.

FIG. 2: An exemplary embodiment of the remote moderator workstation.

FIG. 3: An exemplary embodiment of the remote services network.

FIG. 4: A flowchart showing a startup process of an embodiment of the method.

FIG. 5: A flowchart showing a process of locating a customer's information in the embodiment of the method.

FIG. 6: A flowchart showing a process of setting up a new customer account in the embodiment of the method.

FIG. 7: A flowchart showing a process for validating the identity of a user in the embodiment of the method.

FIG. 8: A flowchart showing a process for accepting a selection by a user of a given service in the embodiment of the method.

FIG. 9: A flowchart showing a process for gathering check information in the embodiment of the method.

FIG. 10: A flowchart showing a process for check validation in the embodiment of the method.

FIG. 11: A flowchart showing a process for managing the validation of one or more pending check in the embodiment of the method.

FIG. 12: A flowchart showing a process of gathering information pertaining to a requested loan in the embodiment of the method.

FIG. 13: A flowchart showing a process of processing a loan in the embodiment of the method.

FIG. 14: A flowchart showing a process of finalizing a loan in the embodiment of the method.

FIG. 15: A flowchart showing a process of making an automated bill payment in the embodiment of the method.

FIG. 16: A flowchart showing a process of redeeming a money order in the embodiment of the method.

FIG. 17: A flowchart showing a process of managing a user queue in the embodiment of the method.

FIG. 18: A flowchart showing a reviewing an correcting encounter information in the embodiment of the method.

FIG. 19: A flowchart showing a finalizing an encounter in the embodiment of the method.

FIG. 20: A flowchart showing a process of collecting a currency payment in the embodiment of the method.

FIG. 21: A flowchart showing a process of making payment to the user or on behalf of the user in the embodiment of the method.

FIG. 22: A flowchart showing a process of establishing the availability of funds on a pre-paid card in the embodiment of the method.

FIG. 23: A flowchart showing a process of dispensing cash or value on a pre-paid card in the embodiment of the method.

FIG. 24: An embodiment of the drawer-mounted document viewer.

FIG. 25: An embodiment of the secure enclosure.

The drawings contain reference numerals to indicate various parts of the illustrated embodiments, as shown below in Table 1.

TABLE 1
REFERENCE NUMERALS IN THE DRAWINGS

| | |
|---|---|
| 1180 | Communications interface |
| 1190 | Videoconference display area |
| 1200 | Data display area |
| 1210 | Primary camera |
| 1220 | Primary microphone |
| 1230 | Primary speaker |
| 1240 | Secure enclosures |
| 1250 | Interchangeable front panel |
| 1270 | Identity card reader |
| 1280 | Signature pad |
| 1310 | Document scanner |
| 1320 | Computing device |
| 1330 | Videoconferencing display device |
| 1340 | Touch screen monitor |
| 1350 | Drawer |
| 1360 | Drawer-mounted document camera |
| 1370 | Receipt printer |
| 1380 | Letter printer |
| 1390 | Magstripe reader |
| 1410 | Check scanner |
| 1420 | Passport scanner |
| 1430 | Driver's license scanner |
| 1440 | Combined passport/driver's license validation device |
| 1460 | First monitor camera |
| 1470 | Second monitor camera |
| 1500 | MICR printer |
| 1510 | Cash dispenser |
| 1520 | Card writer |
| 1530 | Cash acceptor |
| 1540 | Speaker/microphone handset |
| 2000 | Workstation for a remote moderator |
| 2010 | Remote feed display area |
| 2020 | Local data display area |
| 2030 | Workstation camera |
| 2040 | Workstation microphone |
| 2050 | Telecommunications network |
| 2060 | Computing device |
| 2070 | Chroma key screen |
| 2080 | Mirror-image remote feed display device |
| 2090 | Local data display device |
| 2100 | Reflective surface |
| 3000 | Remote services telecommunication network |
| 3010 | Database server |
| 3020 | Database of user identity information |
| 3030 | Chroma key compositing system |
| 3040 | Teleprompter |
| 3050 | Image server |
| 3060 | Background image library |
| 3070 | User identity database |
| 3080 | Audit database |
| 3090 | Queue file |
| 3100 | External service provider system |
| 3110 | Audiovisual recording device |
| 1241 | Drawer-Mounted Document Reader |
| 1242 | Channel guides for front panel |
| 1243 | Drawer slides |
| 1244 | Drawer cover |
| 1245 | Locking mechanism |
| 1246 | Wiring access opening |
| 1247 | Peripheral device |
| 1352 | Inclined drawer surface |
| 1353 | Document to be read |
| 1354 | Transparent panel |
| 1355 | Light source |
| 1356 | Drawer slides |
| 1242 | Channel guides for front panel |
| 1243 | Drawer slides |
| 1244 | Drawer cover |
| 1245 | Locking mechanism |
| 1246 | Wiring access hole |
| 1247 | Peripheral device |

### DETAILED DESCRIPTION

### A. Definitions

The term “telecommunications network” as used herein refers to a network capable of transferring information spatially by conducting signals, such as but not limited to electrical or optical signals. The network itself cannot be construed to be a mere signal. It may be a broadcast-based network, a wire-based network, or a combination. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). In some cases the terms “data link” or “data connection” are used to indicate a digital telecommunications network.

The term “machine-readable format” as used herein refers to a medium of storing information that is configured to be read by a machine. Such formats include magnetic media, optical media, signals, and paper media (punch cards, paper tape, etc.). Printed writing in a human language, if not intended or configured to be read by a machine, is not considered a machine readable format. In no case shall a human memory be construed as “machine readable format.”

The term “module” as used herein refers to a software module, comprising a program or multiple interacting programs which serve a certain function. The module may comprise additional information, such as (but not limited to) data that is used by the program or programs. Despite the nomenclature, a module as used herein need not have interchangeable “modular” characteristics.

The term “including” as used herein is intended to be non-limited, and is to be construed as “including but not limited to” unless explicitly stated otherwise. The terms “comprising” and “comprises” should be similarly construed to be non-exclusive.

All reference to the singular should be construed to include the plural, all reference to the plural should be construed to include the singular, and all masculine and feminine pronouns should be construed to include both masculine and feminine. Unless stated otherwise, it is to be understood that any structure or step described in this disclosure may be embodied in multiple parts or acts; and that any group of structures or steps may be embodied in a single combined part or act.

### B. Videoconference Access Facility

This disclosure provides a videoconference access facility to provide services to users who may be unbanked, under-banked, functionally illiterate, functionally illiterate in a local vernacular language, reluctant to transact business via computer interface, remote from suitable services establishment, or unavailable to transact business during working hours.

In a general embodiment, the videoconference access facility comprises a means for identifying a user electronically, a means for teleconferencing between the user and a moderator, a means for creating a payment instrument, and a means for transmitting and receiving data between the user and the moderator.

Another general embodiment of the facility comprises a communications interface linking the facility to a remote moderator over a telecommunications network; a videoconference display area; a data display area; a primary camera positioned to capture an image of the user's face; a primary microphone capable of capturing voice-quality sound; a primary speaker capable of producing voice-quality sound; a plurality of secure enclosures extending to the front of the facility, each capable of interchangeably containing a peripheral device, and each comprising an interchangeable front panel to provide partial access to the peripheral device by the user; an identity reader to transmit identity data to the remote moderator, located in one of the said enclosures, the identity reader selected from the group consisting of: an identity card reader, a signature pad, a fingerprint reader, a barcode scanner, and a document scanner; and a computing device connected to the communications interface and configured to exchange data with the videoconference display area, the data display area, the primary camera, the primary microphone, the primary speaker, and the identity reader.

The primary speaker and the primary microphone facilitate verbal communications between the user and the remote moderator. The primary speaker and the primary microphone may assume a variety of configurations. For example, they could be incorporated into a telephone-style handset. The primary speaker could also be part of an earpiece, and the primary microphone positioned on the body of the facility to pick up the user's voice. These two configurations have the advantage of allowing the moderator to communicate to the user without being overheard or to provide hands-free verbal communication. However, any suitable configuration can be used. Some embodiments of the facility comprise a telephone-style handset to enable the user to verbally converse with the moderator with a degree of privacy. In some embodiments the handset is provided in addition to a primary microphone and primary speaker positioned to allow a user to carry on a dialog with the remote moderator simply by speaking in proximity to the facility; other embodiments comprise only the handset or only the exterior speaker and microphone. In some embodiments of the facility, picking up the handset disables the speaker on the exterior of the facility, preventing the moderator's side of the conversation from being overhead.

Additional speakers may be present on the facility. For example, a broad-area speaker may be mounted on the cabinet of the facility for the purpose of announcing the facility's services and status, while another speaker is present on the handset to facilitate confidential communications with the user. The broad-area speakers may be used to manage a user queue, as further described below.

Some embodiments of the facility comprise a primary camera positioned to capture an image of the user's face. This aids in identifying the user for those transaction that require such identification. This also aids in creating a videoconference between the moderator and the user. The primary camera is configured to transmit the image of the user's face to the moderator. Some embodiments of the primary camera are configured to transmit the image of the user's face to a database of user identity information. The image may also be transmitted to a biometric recognition system. The primary camera is capable of capturing still images, moving images, or both. Multiple cameras may be present. Multiple cameras may provide better images of the user's face, can observe the surroundings of the facility for security purposes, and can allow monitoring of the various devices on the facility (such as the cash dispenser or printer). Some embodiments of the facility comprise a monitor camera positioned to capture an image of the front of the facility from a first angle. Further embodiments of the facility comprise a second monitor camera positioned to capture an image of the front of the facility from a second angle. Such monitor cameras can advantageously provide images of the user's hands and the various peripheral devices present on the facility to allow the moderator to observe improper use of the facility or tampering, and to allow recording of all user movements for future reference (such as audits).

Lights may also be present to provide illumination at night or indoors. Signal lights may also be present to indicate which devices on the facility should be used for the user's purpose.

The videoconference display area facilitates communication by receiving a live video or still image of the moderator during conversation. Displaying the moderator during conversation will encourage use by those who dislike interacting with a “faceless” remote party, and can instill an increased sense of trust and personal attention during an important transaction. The videoconference display area may be on the same display device as the data display area. Such embodiments have the advantage of requiring only a single display device. In other embodiments of the facility the videoconference display area and the data display area are on separate display devices.

The data display area provides information other than the video or still images of the moderator. Such information may be in written form or may be illustrated as pictures or animation. Written information has the advantage of clarity of meaning. Illustrations have the advantage of being comprehensible regardless of the language capabilities of the user or of the user's literacy status. The information may be, for example, instructions as to how to use the facility, requests for information, or information about a requested service. Some embodiments of the data display area provide an accompanying user interface, such as a touch-screen monitor or buttons adjacent to the display. Touchscreens have the advantage of simplifying user-required actions and can take advantage of graphical icons rather than buttons or key inputs.

The data display device may comprise a touch screen.

In some embodiments of the facility the videoconference display area is positioned at about eye-level of the average user. In other embodiments it is positioned slightly above eye-level. Such embodiments have the advantage of simulating an eye-to-eye conversation during the teleconference. In further embodiments the data display area is located below the videoconference display area, in a position that is accessible to one or both of the user's hands. Such embodiments allow the user to interact with a touch screen or other user interface associated with the data display area. In any case, both display areas will be visible to the user.

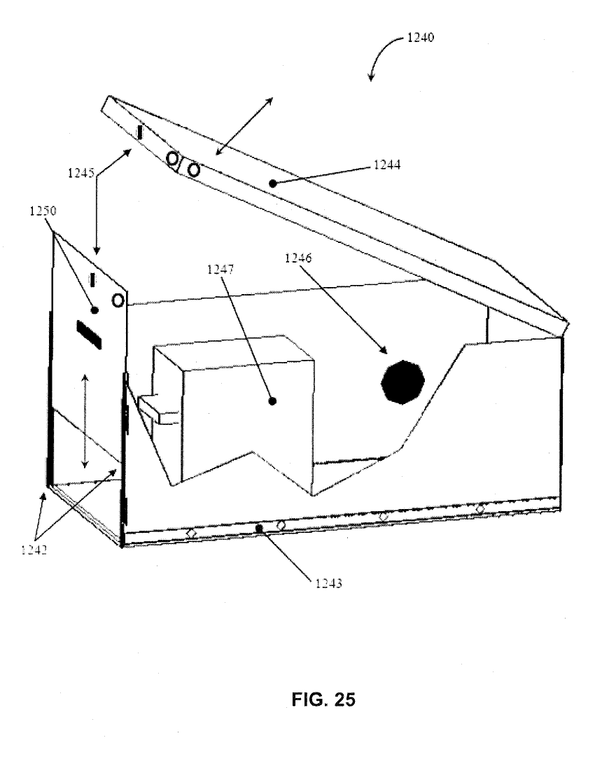

Some embodiments of the facility comprise a plurality of secure enclosures extending to the front of the facility that are capable of interchangeably containing a peripheral device, that comprise an interchangeable front panel to provide partial access to the peripheral device by the user. One version of the enclosure is shown in FIG. 25. The enclosures allow peripheral devices of various types to be easily installed in the facility in response to needs for various services. The interchangeable front panel allows the installation of front panels that are specific for a given peripheral, and allow the user to gain limited access to the peripheral while maintaining the security of the peripheral. In this context “limited access” means that the user can use the peripheral as needed without the ability to remove the peripheral or damage it. For example, the front panel could be configured to allow a user to insert an ID card with a magnetic strip (“magstripe”) into a magstripe reader without allowing the user to remove the magstripe reader from the enclosure. The secure enclosures allow the repurposing or upgrading of the facility in the field for a wide variety of uses without the need for removing the facility from a field location or replacing it entirely. This repurposing ability can allow the facility to maintain its functional lifespan longer than single purpose facility which may not be upgradeable without removal and replacement of the entire facility.

Some embodiments of the front panel comprise a pair of vertical channel guides to allow the front panel to be slid in and out of position. Some embodiments comprise an upper drawer cover to provide additional security; in addition a locking mechanism may be present to lock one or both of the upper drawer cover and the interchangeable front panel in place. A means for providing wiring access may be present (although it is also contemplated that peripherals that require no external wiring, such as battery-powered peripherals and Bluetooth peripherals).

Examples of peripheral devices that may be placed in the enclosure(s) are a receipt printer, a letter printer, a magstripe reader, a smart card reader, a check scanner, a passport scanner, a driver's license scanner, a combined passport/driver's license validation device, a signature pad, a first monitor camera positioned to capture an image of the front of the facility from a first angle, a second monitor camera positioned to capture an image of the front of the facility from a second angle, and a document camera positioned to capture the image of a document placed on a viewing surface. The peripherals will be connected to the computing device in such a way as to allow them to exchange data with the computing device.

Some embodiments of the facility comprise a document scanner configured to capture and retain the document. The user feeds a document to the document scanner, which scans the document and stores it. The scanned image is then sent to the moderator. The moderator may then send instructions to the facility to retain the document or return the document to the user. This is useful in many applications. For example, if the user obtains a loan using the facility, the user can submit the signed loan agreement using the document scanner, which then retains the original signed agreement. If the scanned image of the agreement indicates that it has been properly executed, then the moderator may instruct the facility to return the agreement to the user to be properly executed.

Some embodiments of the facility comprise a check printer. The check printer is configured to print a check of a standard size. A source of blank checks may provide blank checks for printing with built-in security features. One embodiment of the check printer is an MICR printer. MICR printers are known in the art, and generally employ security features such as magnetic ink, magnetic toner, and certain fonts to allow automated authentication.

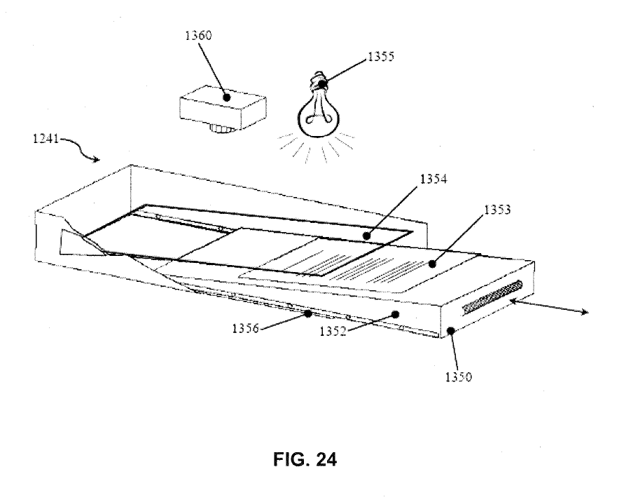

Some embodiments of the facility comprise a drawer-mounted document reader. One version of the drawer-mounted document reader is shown in FIG. 24. The drawer-mounted document reader comprises a sliding drawer pad with an inclined document surface, a pair of drawer slides, a transparent panel having the same inclination as the document surface, and a document camera positioned to capture an image of the document when the drawer is in the closed position. The document is placed on the document surface while the drawer is open. When the drawer is closed, the document is sandwiched in between the transparent panel and the document surface. Some embodiments of the drawer-mounted document reader further comprise a light source positioned to illuminate the document and of sufficient intensity to allow the document camera to capture an image of the document.

Some embodiments of the facility further comprise a means of receiving payment. The means of receiving payment may be a cash receptacle. The cash receptacle may be any such device that is known in the art, as are often found in vending machines, change machines, and gambling-chip dispensers. They typically provide for detecting the denomination of a bill and verifying its authenticity. This is achieved by various methods known in the art, such as using a magnetic scanner to detect the magnetic ink in U.S. currency, measuring the fluorescence of the bill under ultraviolet light, and comparing the optical qualities of the bill to standards stored in memory. The cash receptacle may also include a coin slot and an accompanying mechanism for determining the denomination of the coin.

The means of receiving payment may be an image-capture device, such as a scanner, configured to scan, hold, return, and/or capture a scanned image of a paper financial instrument, such as a check or a money order, and transmit (directly or indirectly) the scanned image to a verifier. The image may be, for example, a Check-21 compliant TIFF or JPEG image. The image may be transmitted to the check verifier by way of the moderator; in some embodiments the moderator will view the image, determine whether it is of sufficient quality to be evaluated by the check verifier, and based on that determination either transmit the image to the check verifier or request the user re-scan the check. Examples of suitable check scanners are the Reiner RS-891/894 or the CTS SB50E.

The means of receiving payment may be a card reader, capable of reading at least one of a prepaid card or a credit card. Prepaid cards are well known in the art, and include debit cards, calling cards, and gift cards. The card reader may be used to retrieve funds or to retrieve information about the cardholder. The card reader may also be used to establish the user's identity. Identification cards, such as driver's licenses, passports, passport cards, central access cards, membership cards, and resident alien identification cards are examples of cards that are machine readable (either due to the presence of a magstripe or a machine-readable zone). Any of these may be used to establish the identity of the user using a card reader.

In embodiments of the facility in which the facility is intended for transactions that require verification of the user's identity, the facility will comprise an identity document reader. The identity document reader will be configured to gather data from the identity document and transmit the data to the remote moderator. The identity document reader may be an image capture device (such as a scanner) configured to capture an image of an identity document, such as a driver's license, military identification, resident alien identification, or passport. The identity document reader may also be a drawer-mounted document viewer. The identity document reader may also be a card reader that reads a magnetic or optical pattern on an identification card; such patterns are present on the drivers' licenses of some U.S. states and on the Common Access Card issued to members of the U.S. military. It may also be a reader that interfaces with a microchip on a smart card. Some embodiments of the identity document reader are a driver's license scanner, a passport reader, or a combination driver's license reader/passport reader (such as the commercially available 3M ePassport Reader). Such devices are known in the art, and typically comprise one or more of a camera, a visible light source, an ultraviolet light source, an infrared light source, an RFID reader, a barcode rader, and a magstripe reader. The identity document reader may be any other such reader known in the art, such as a barcode reader, that is capable of reading information about the user from the identity document. In some cases the user may have a membership card relating to the organization that operates the facility that serves as the identity document. Alternatively, the identification card may relate to an organization that leases the facility or buys the right to use the facility from another organization.

The facility may comprise a device to transmit payment to the user. The device may be, for example, a cash dispenser. Cash dispensers are well known in the art, and are commonly found on automatic moderator machines. The cash dispenser will ideally be compact and secure. An example of a suitable cash dispenser is the Talaris NMD100 cash dispensing module.

The device to transmit payment to the user may be a printer configured to issue a money order. Information about the payee of the money order may be received verbally by the remote moderator through the microphone at the facility, or it may be provided via the user interface at the facility. Information as to the amount of the money order and the payee is transmitted by the moderator to the printer at the facility. An image of the money order may be captured after printing and prior to dispensing the money order to the user.

The device to transmit payment to the user may be a card writer, configured to add value to a new or pre-existing debit card, calling card, gift card, public transit card, or other type of prepaid card. The debit card may be a typical cash debit card for general use, or it may be only for specific uses.

Some embodiments of the facility comprise an audiovisual recording device. The audiovisual recording device can be used to store images and sound picked up the cameras and microphones. An audiovisual record can be made of a given encounter with a user or a specific transaction with a user. In a specific embodiment the audiovisual recording device is a digital video recorder (DVR). Records made on the device may be accessible to the remote moderator or other systems. Such records may be managed to allow future audits; for example, records on the audiovisual recording device may be periodically uploaded to a server for long-term storage.

The facility comprises one or more data connections to the remote moderator to transmit the information gathered by the facility about the user and the transaction to the moderator.

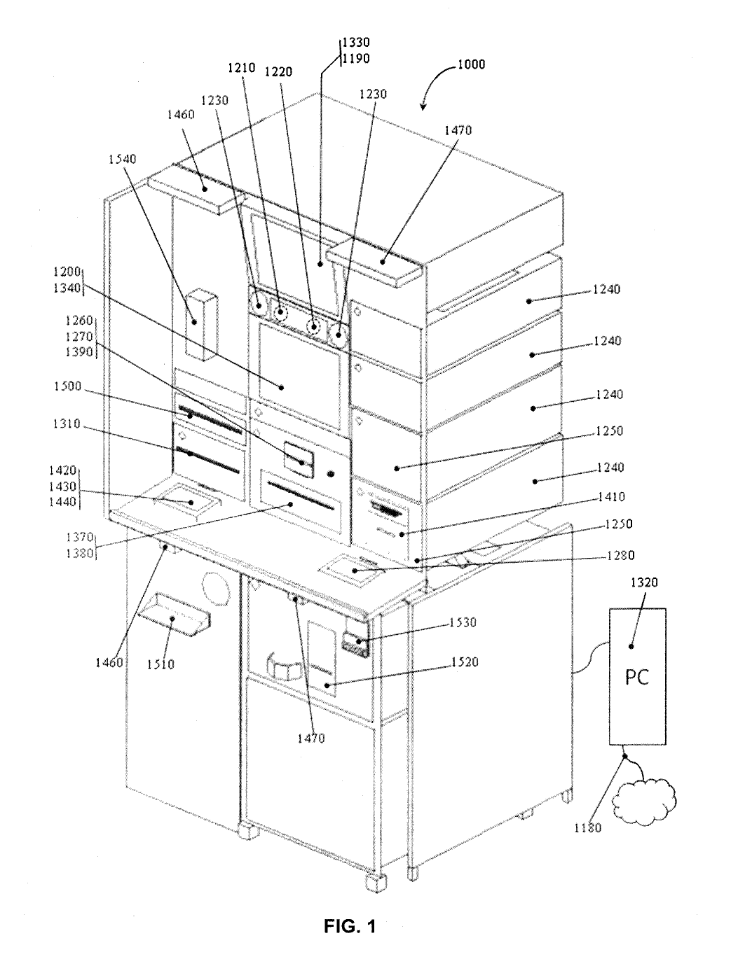

FIG. 1 illustrates an exemplary embodiment of the facility.

### C. Method of Providing a Service with a Videoconference Access Facility

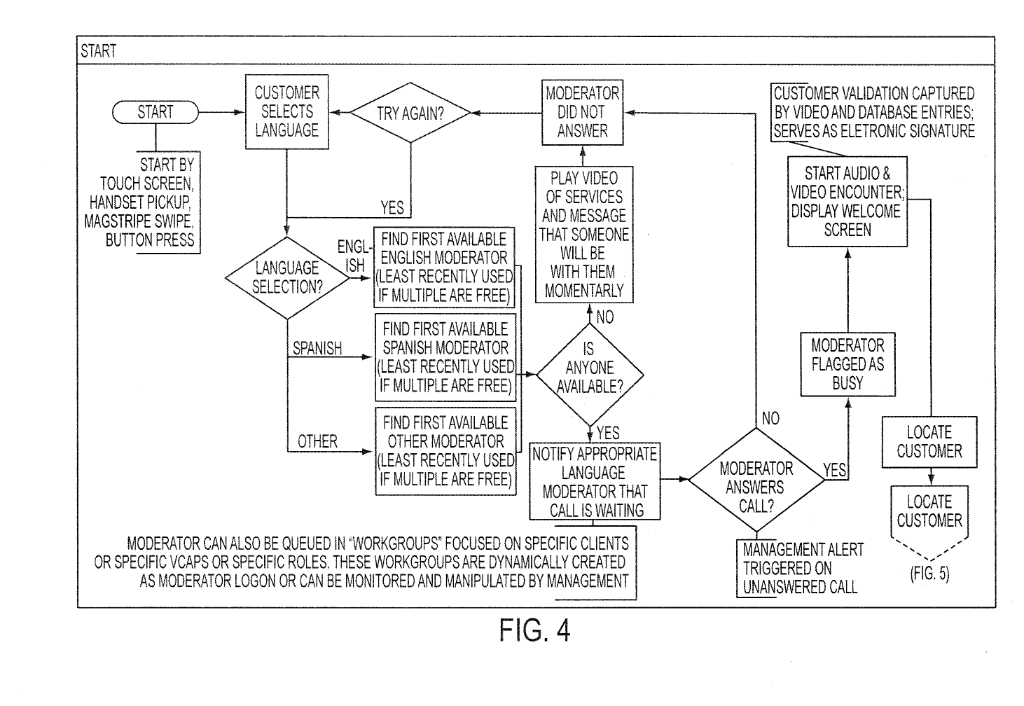

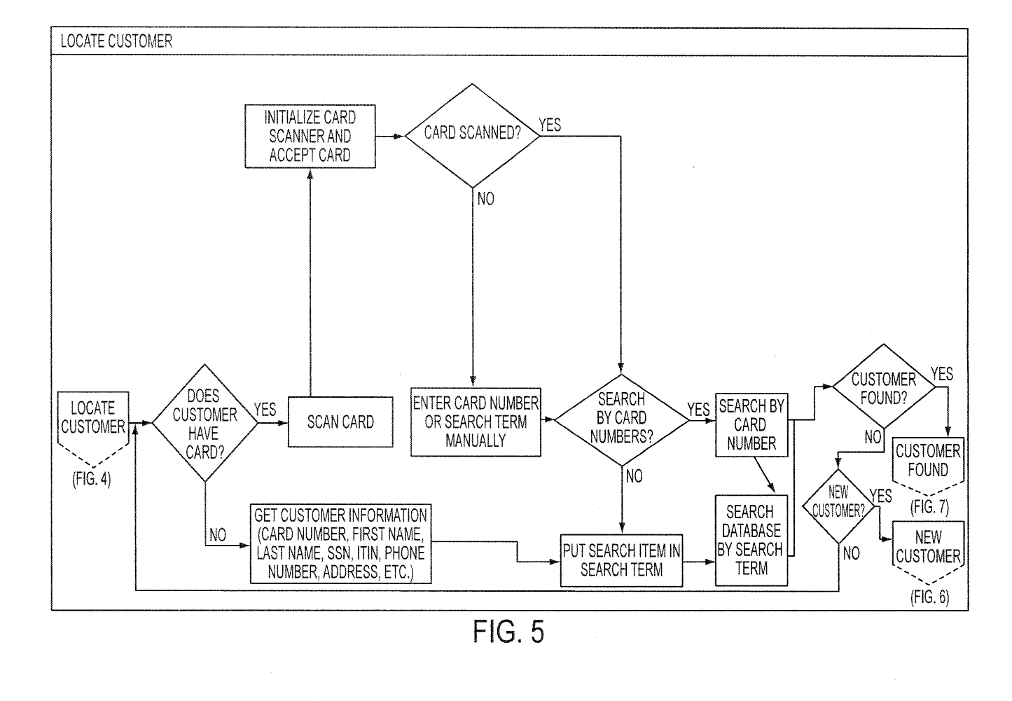

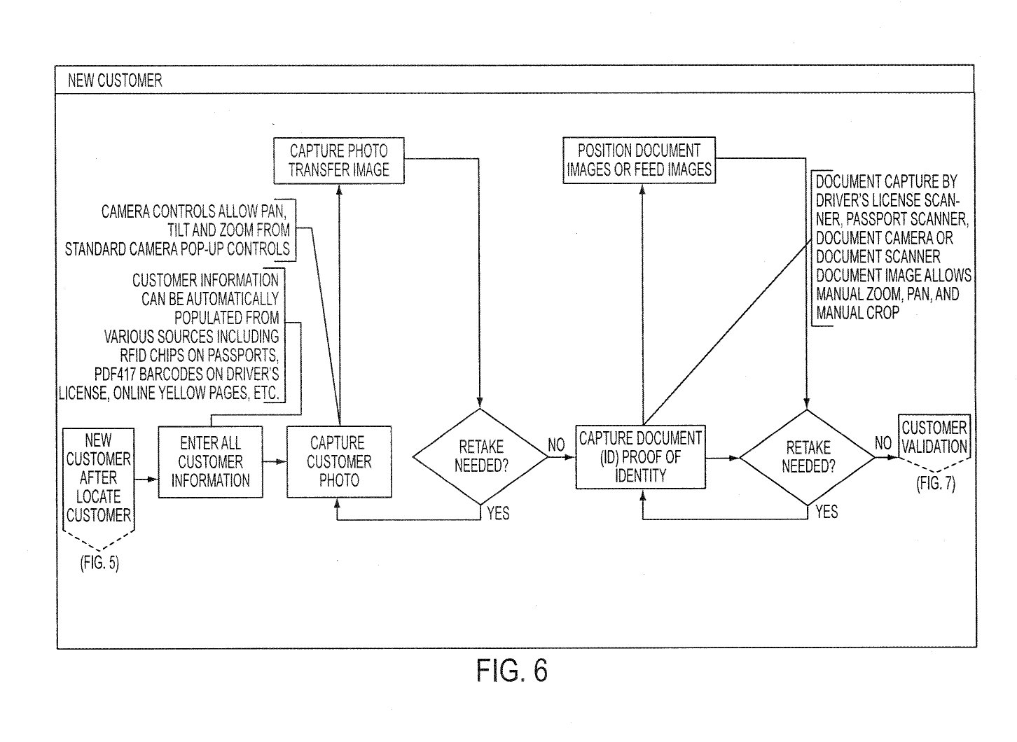

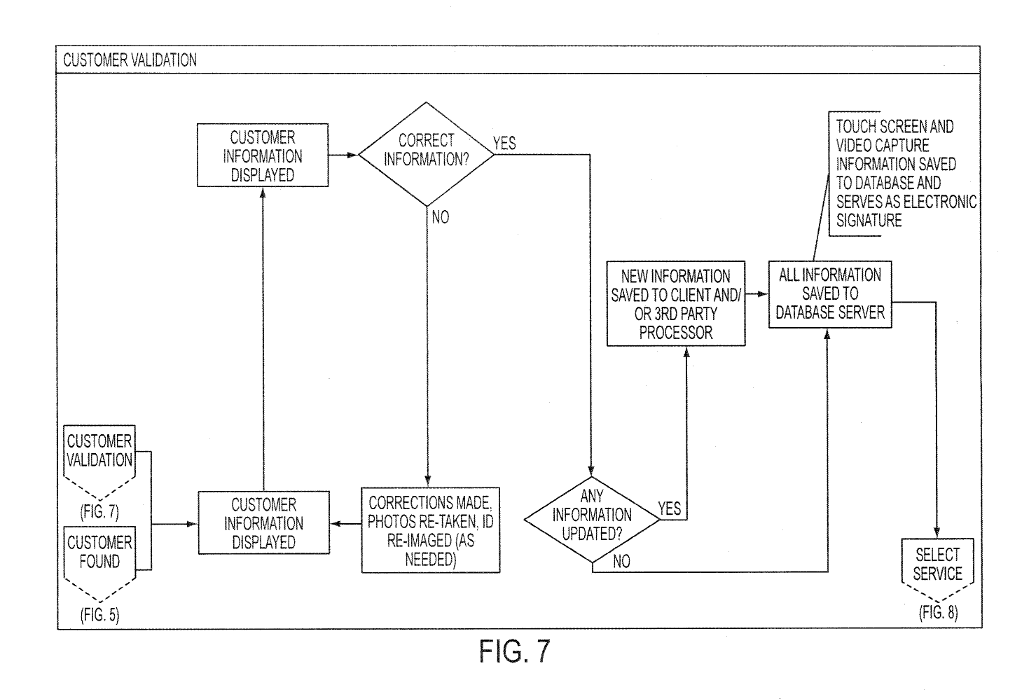

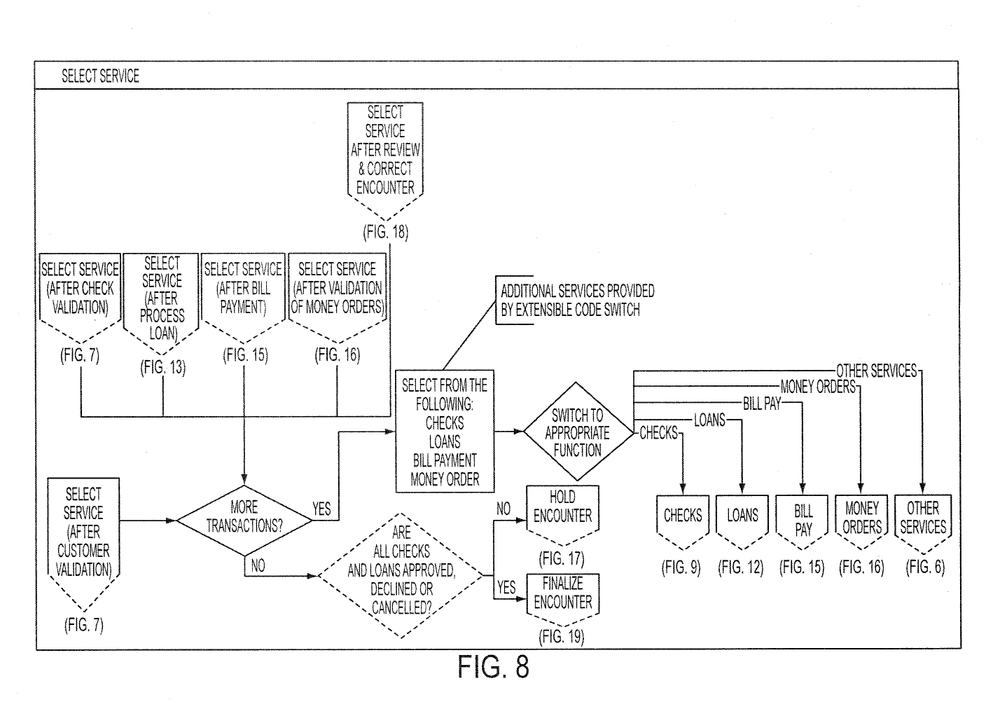

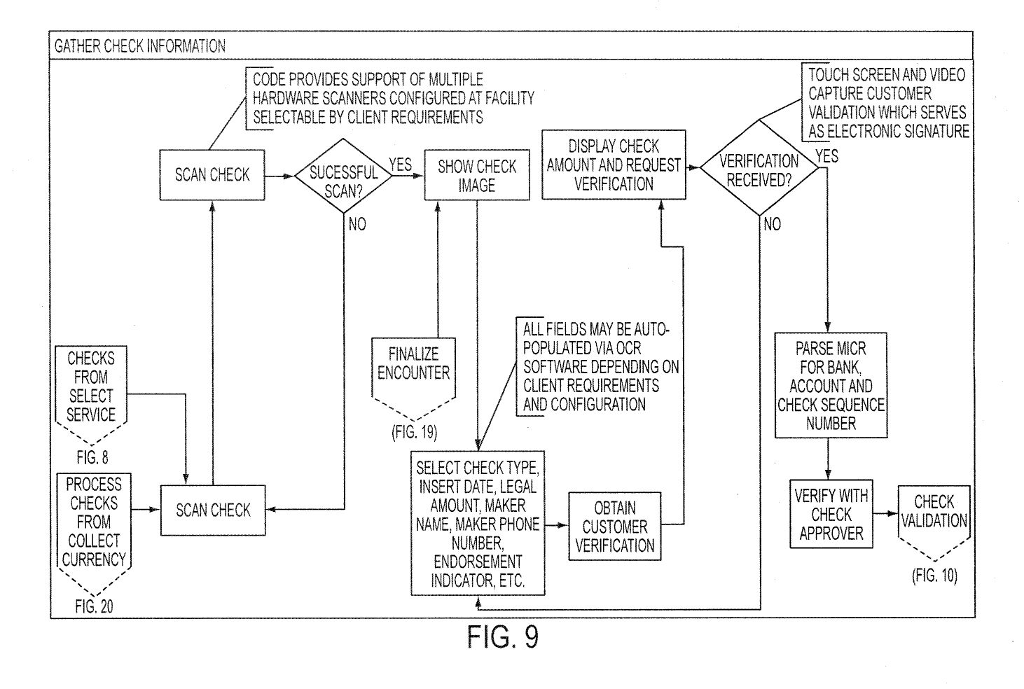

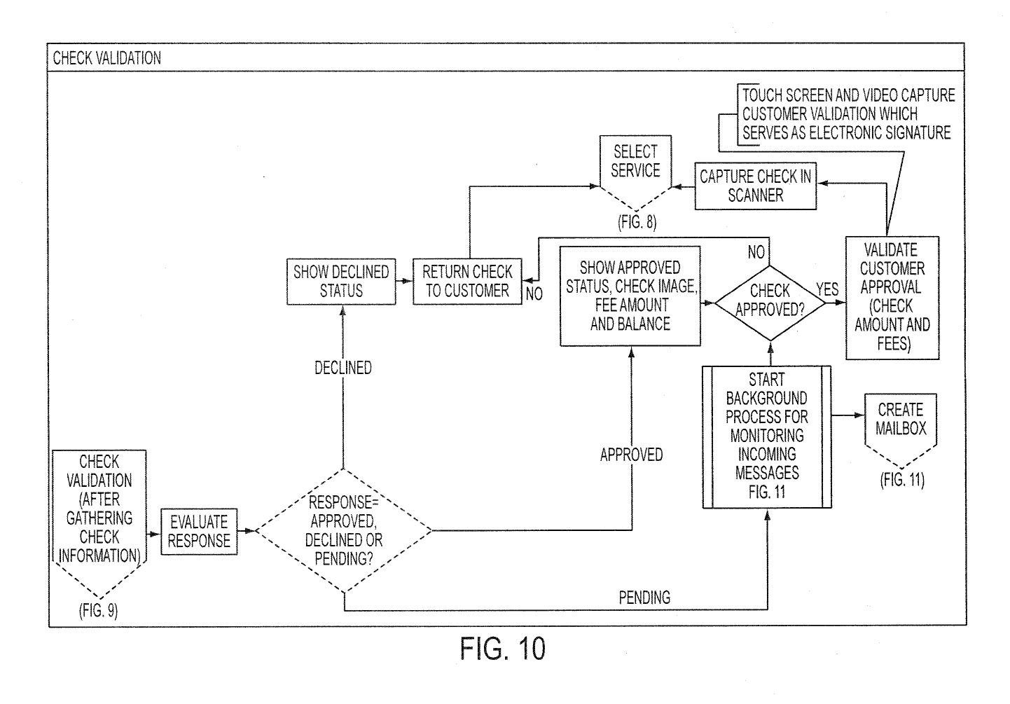

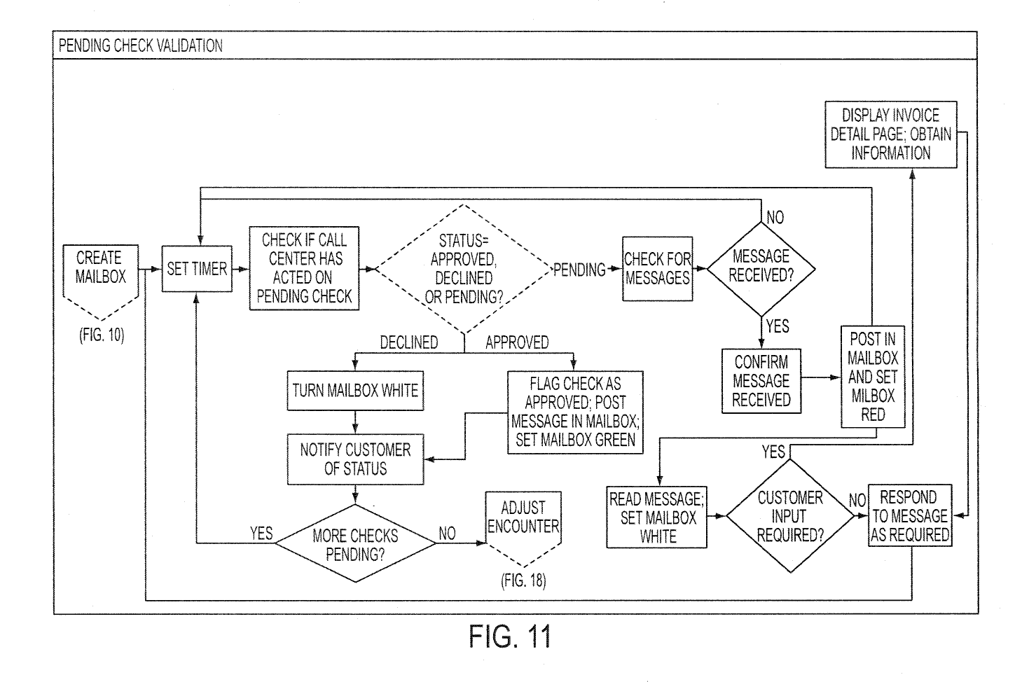

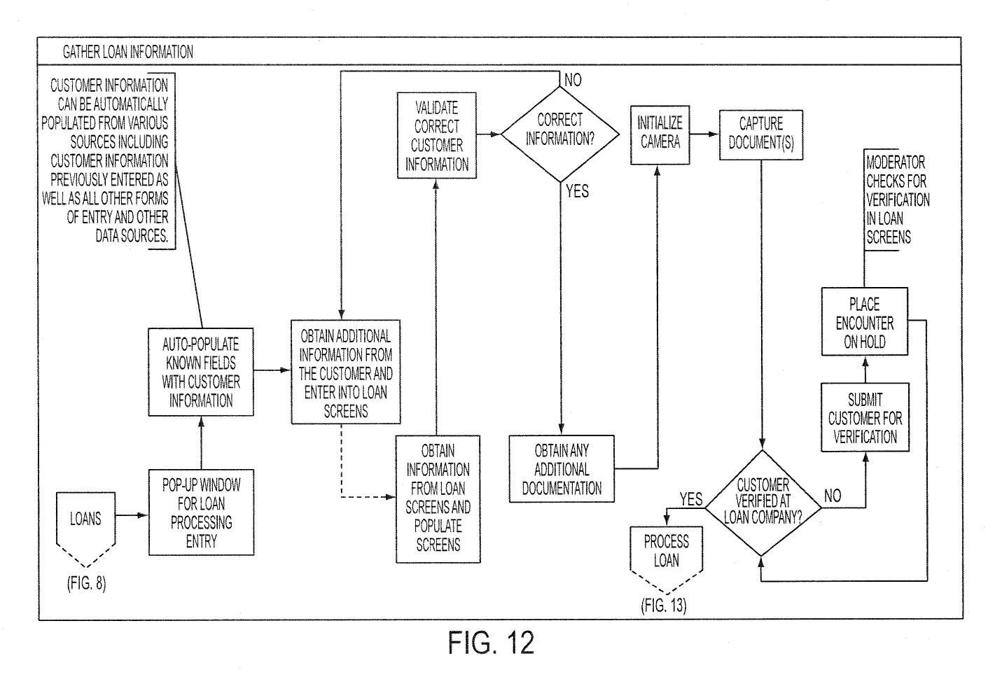

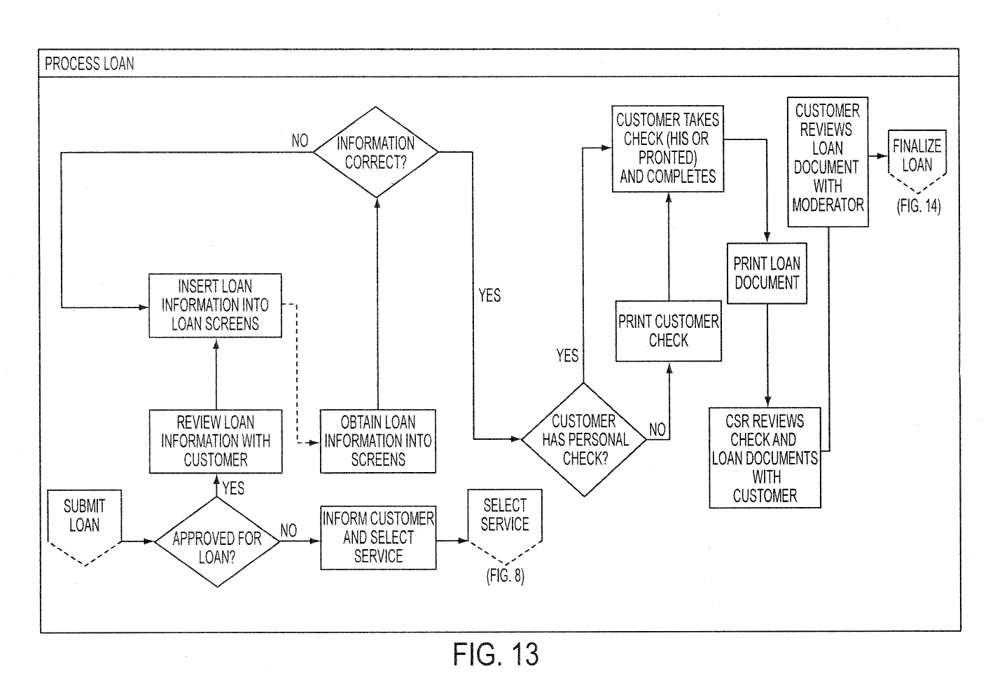

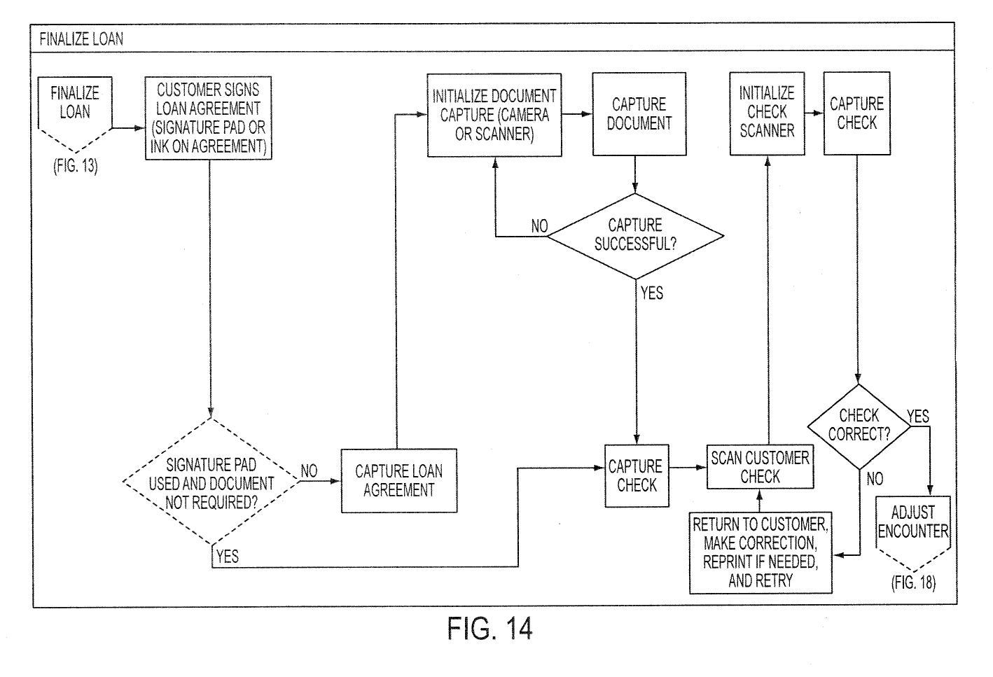

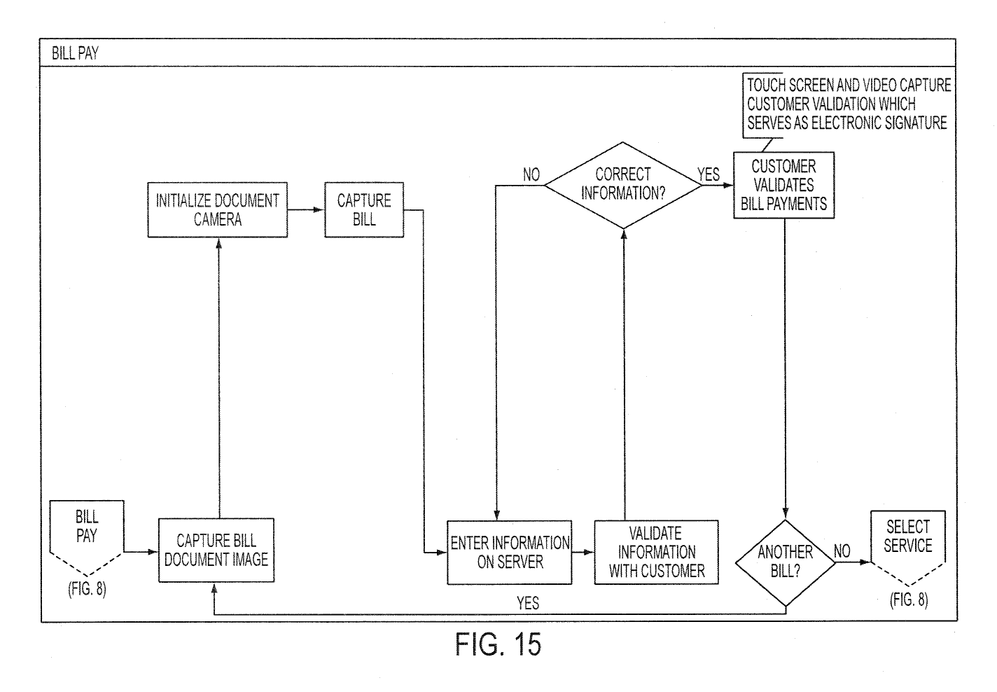

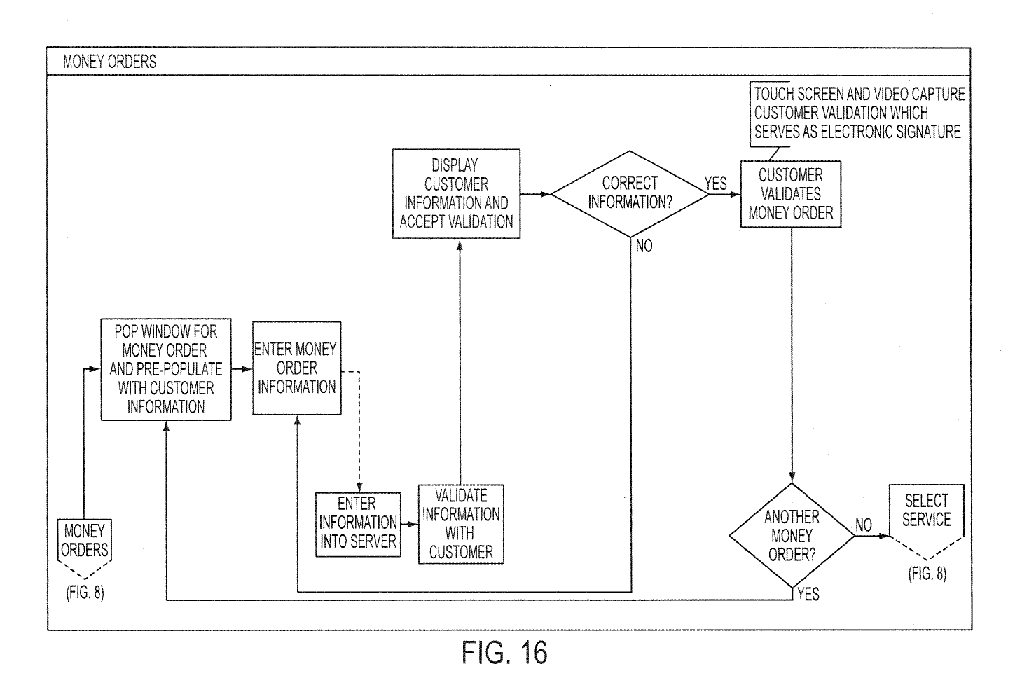

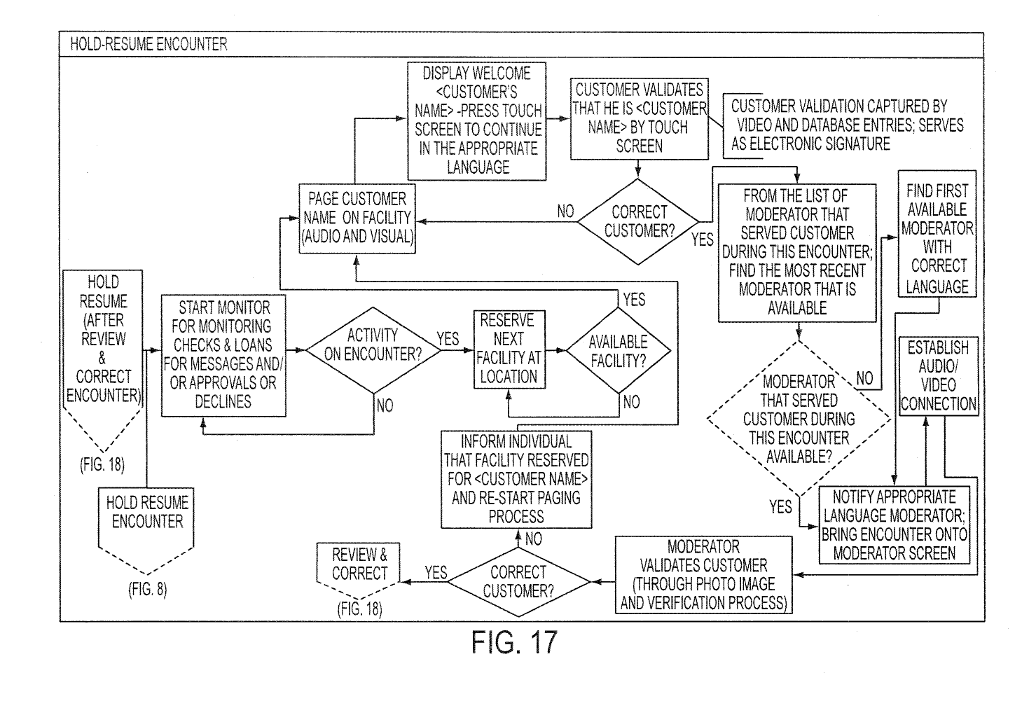

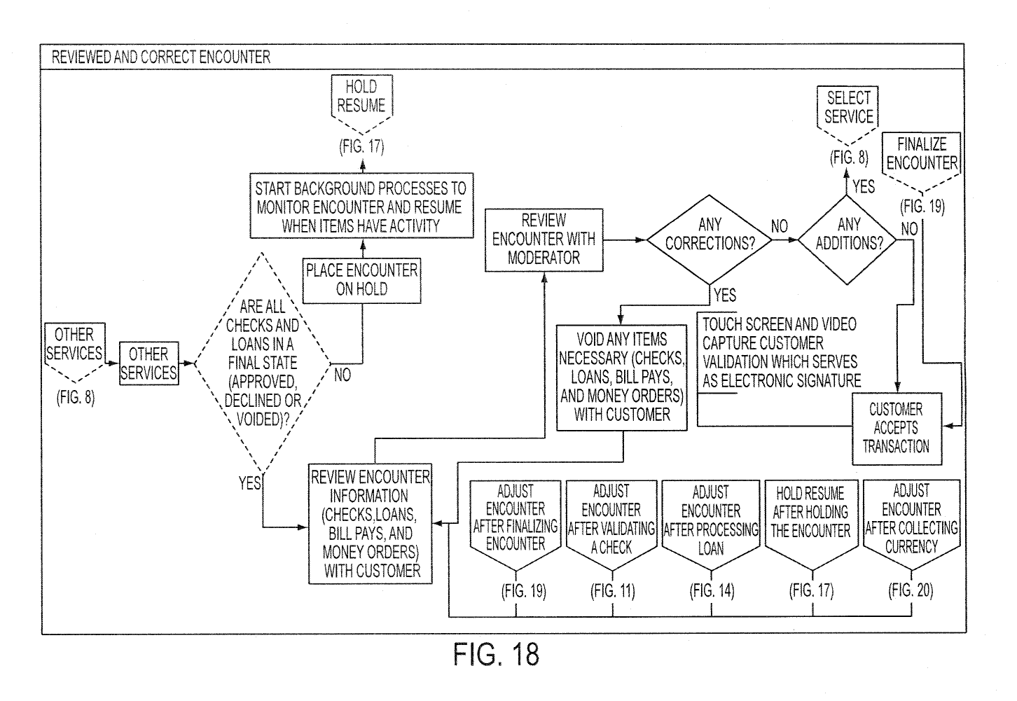

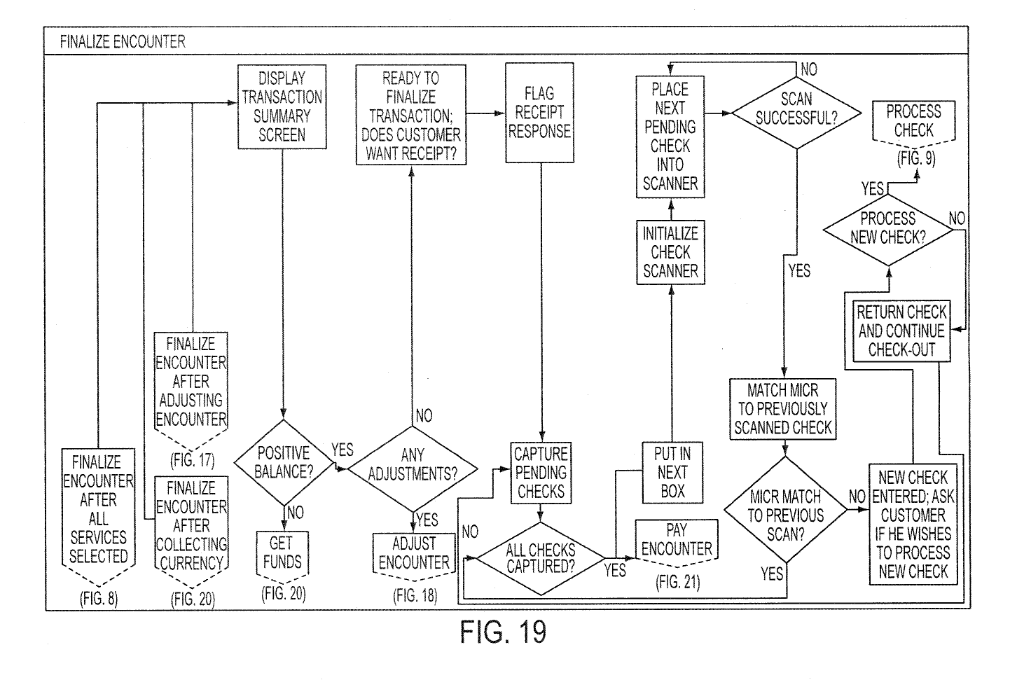

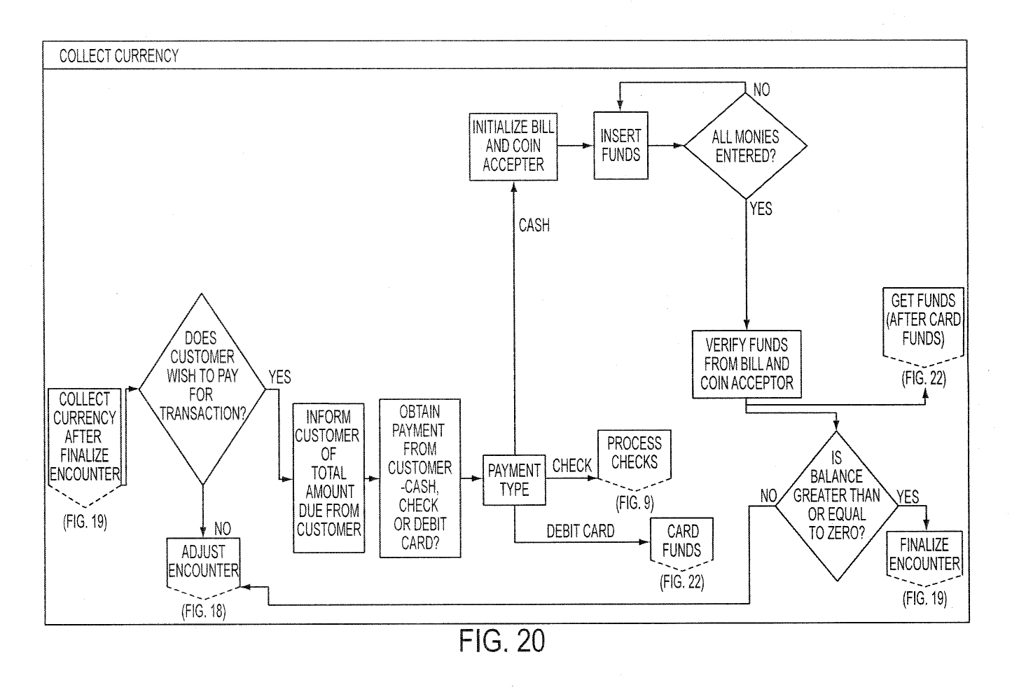

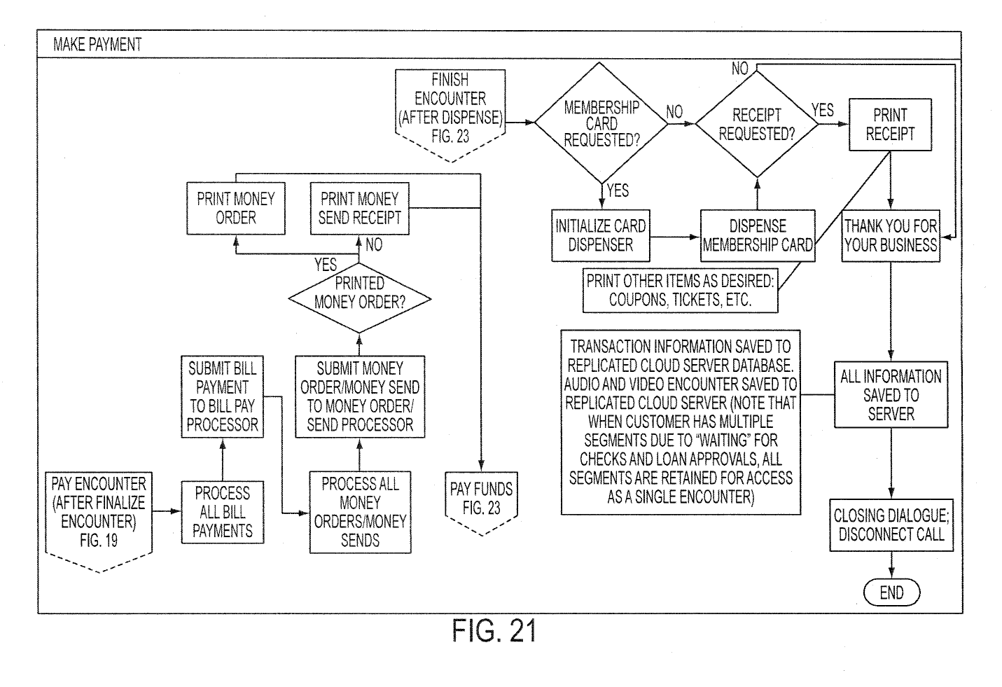

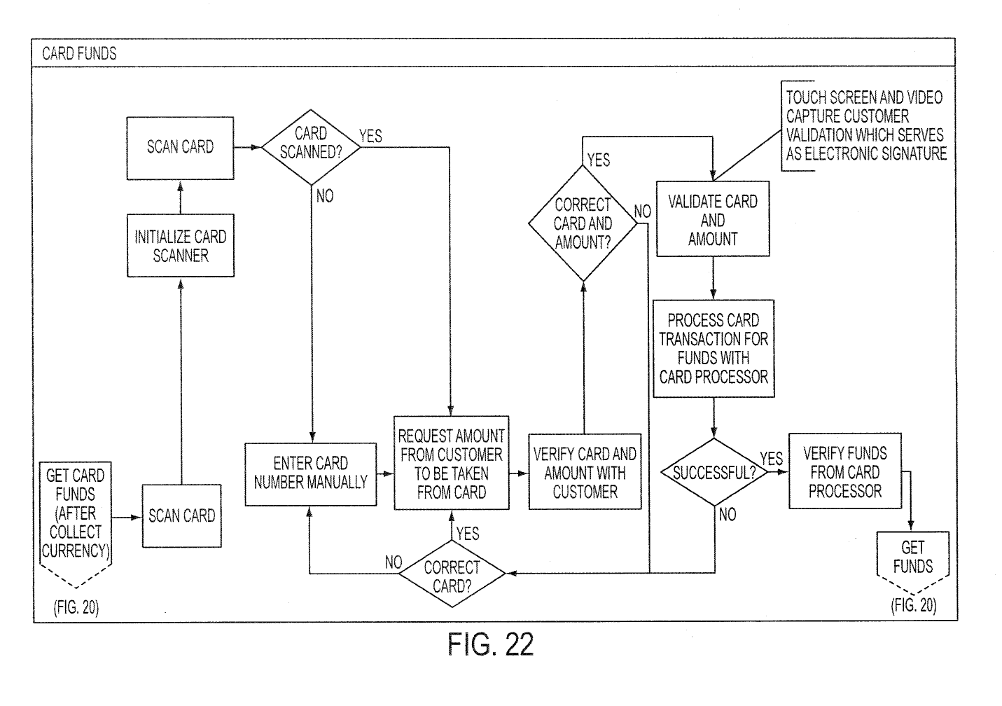

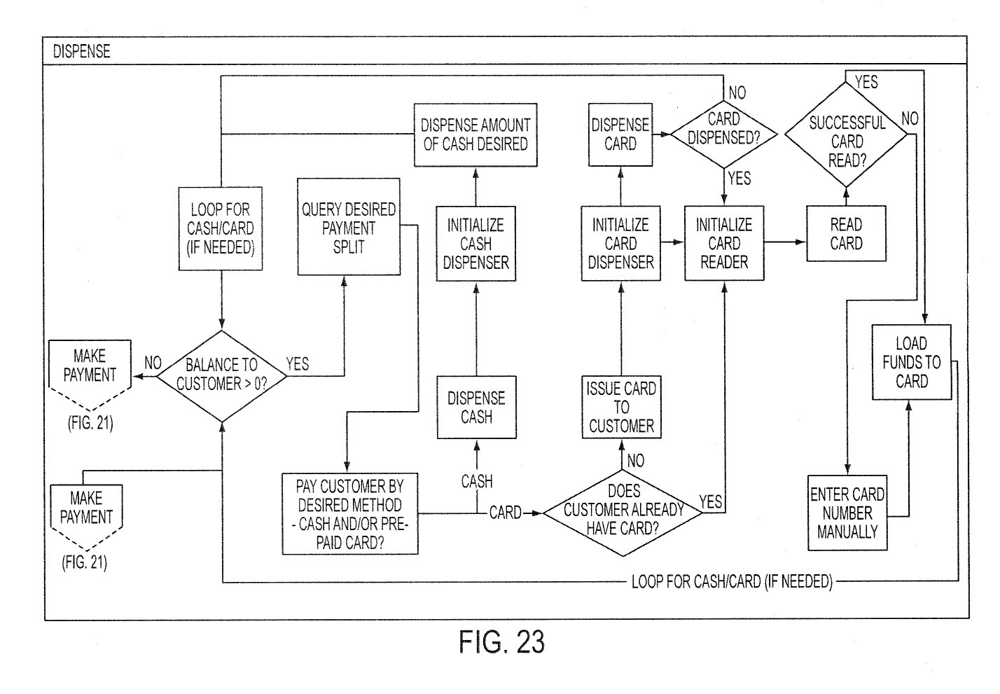

Methods are provided of providing services and performing a financial transaction using the financial telecommunications facilities described above. An embodiment of the method is illustrated in FIGS. 4-23. Different types of transactions may be accomplished using the facility. Some embodiments of the method comprise the steps of establishing the identity of the user, establishing the availability of funds, and transmitting payment. Further embodiments of the method comprise establishing the identity of the user, establishing the user's eligibility for a public service, and transmitting payment or providing an official document as necessary. Further embodiments comprise providing an educational presentation, registering a vehicle, applying for a license, and renewing a license.

Another general embodiment of the method is a method of providing a verbally-mediated service to a user from a plurality of available services via a videoconference, without reference to or requirement for a bank account of the user, comprising: establishing a videoconference with the user of a videoconference access facility via a telecommunications network; receiving a request for the service from the user via the videoconference access facility; receiving identifying information from the user via the videoconference access facility, said identifying information comprising an image of the user's face captured by the videoconference access facility; transmitting the user's identity to a service-provider computing system; receiving service-related content from the service-provider computing system; and transmitting the service-related content to the user over the network. Further embodiments comprise accessing a service-provider interface module from an interface module library, said interface module library comprising a plurality of service-provider interface modules, wherein the service-provider interface module enables direct communication to the service-provider computing system.

Another general embodiment of the method comprises providing a verbally-mediated service to a user from a plurality of available services via a videoconference, without reference to a bank account of said user, by a method comprising: establishing a videoconference with a remote moderator from a videoconference access facility via a telecommunications network; transmitting a request for the service from the user via the videoconference access facility; transmitting identifying information from the user via the videoconference access facility to the remote moderator, said identifying information comprising an image of the user's face captured by the videoconference access station; and receiving service-related content from the remote moderator and providing the content to the user. In a further embodiment, the service-provider is a governmental benefits provider, and the method further comprises: transmitting a request from the user to receive a governmental benefit; and transmitting eligibility information from the user.

The videoconference may be established using any of the videoconference access facilities described herein. Similarly, the remote moderator may be located at any of the workstations described herein.

The establishment of the user's identity comprises capturing an image of the user's face with a camera and transmitting the image to the remote moderator. The remote moderator can then compare the image taken of the user with images from other identity records.

The user may provide the other identity record at the time of the transaction, or the moderator may retrieve the other identity record from a database server comprising a database of user identity information developed from previous transactions or other sources. For example, the moderator could request a digital image of the user's driver's license from a state motor vehicle agency's online system. In another example, the organization that maintains the videoconference access facility also maintains a database of members, including a photograph, which the remote moderator may retrieve from the organization's database server.

Some embodiments of the step of identifying the user further comprise receiving identifying information with an identity document reader to corroborate the user's identity, and transmitting the identifying information to the remote moderator. The identity document reader can be any device that is suitable for use in the facility, as described above. If the identifying information is a captured image of a document, the image may then be examined by the remote moderator. The remote moderator may then verify the document with the issuing governmental agency or private entity. Such embodiments may further comprise sending an electronic query to a governmental database server requesting verifying information. The database query may result in a confirmation of the existence of the person associated with the identity document, in transmission from the government database server to the moderator of an image of the user's face, or other identity information. Such information may also be retrieved from a database on a database file server containing user information if the information has been submitted previously and recorded.

The step of identifying the user may further comprise gathering additional physiological or biometric information about the user. This may be any type of physiological or biometric information that is known in the art to be useful for establishing the identity of an individual. Well known examples include collecting a thumbprint, a voice print, and a scan of the user's iris. Other methods of establishing the user's identity are contemplated. For example, a second user of confirmed identity could vouch for the user's identity, and the user could submit a birth certificate; the image of the birth certificate could be verified, and a record made of the vouching party, the user's facial image, and the birth certificate. Once verified, such a process could serve to issue a photographic identification document.

If the user is the intended recipient of a money transfer, the identifying step may comprise receiving a code from the user corresponding to the money transfer. Two common types of money transfer, MoneyGram and Western Union, allow recipients of a transfer to identify themselves with a money transfer control number. The code can substitute for either of the image of the user's face or the identity document. The code is used to confirm the eligibility of the user to receive a money transfer. Because the code is held in confidence by the intended recipient, if the user provides a code corroboration of the user's identity is a lower priority.

Establishing eligibility for public services comprises transmitting the user's identity information and information regarding any supporting documents to a governmental system for verification. The governmental system may comprise a fully automated computerized system, a system involving a human operator, or a combination. The system may be an online system, for example. The results of the governmental validation will be received via a telecommunications link by the moderator, who will send an appropriate response to the facility. Depending on the service, the method may further comprise dispensing payment to the user. Payment may be dispensed by any method described below. Payment may be made in different forms for different services. For example, funds from a tax refund may be provided in any form (cash, money order, debit card balance adjustment, etc.); the same is true of Social Security payments. Payment as part of a food stamp entitlement could take the form of printing the food voucher at the facility or issuing a food stamp debit card. In some cases, payment is not appropriate. For example, if the public service is eligibility for low-income housing, the facility may instead print a certification document. If the service is satisfaction of a fine for a parking ticket, the facility may simply print a receipt. If the service is election of a health insurance carrier via a health insurance exchange, then the method may further comprise printing the user's policy.

Various processes may be employed to establish the availability of funds. In one embodiment, the availability of fund is established by issuing credit to the user based on the identity of the user and credit information pertaining to the user. In such embodiments a short-term loan is issued by retrieving credit data from a credit reporting agency's online system, and determining the amount of the loan and the terms based on the credit data. The terms of the loan may be printed at the facility or displayed on a video screen. The user's assent may be obtained verbally, by presenting a touch-screen object indicating assent, by obtaining the user's signature on a signature pad, or a combination of these. In some instances the user might be pre-approved for a certain amount of credit, in which case the credit information pertaining to the user may be maintained on a user information database accessible by the remote moderator. In other instances, a paper agreement may be produced by the facility's printer, which is then signed by the user, and the image of the signed agreement is captured using the image capture device.

In another embodiment, establishing the availability of funds comprises receiving cash at the financial facility by means of a cash receptacle. This may be any cash receptacle that is described as suitable above for use with the facility.

In some embodiments of the method the availability of funds is established by reading a prepaid card at the facility. Any amount up to the balance of the card could be utilized in the service or transaction. In such embodiments the facility will write a lower value on the card based on the amount of value used in the service or transaction.

A further embodiment of the method comprises receiving a paper financial instrument at the facility and transmitting a scanned image of the paper financial instrument from the facility to a verifier. The scanned image is obtained using an image capture device of the kind described above. The paper financial instrument may be a check or a money order. The verifier may be a computerized system, a live person, or a combination system capable of verifying the authenticity of a check, estimating the risk that the issuing institution will not honor the check, and optionally insuring the check if approved. An exemplary verifier in the case of a check is Chexar. In addition, if the instrument is a check, the method may further comprise transmitting the scanned image of the instrument to a remote deposit capture system, such as that maintained by Clear Payment, Inc.

Some embodiments of the method in which availability of funds is verified via check further comprise receiving the image of the check by the remote moderator; transmitting the check information to a check verification system; transmitting the check information to a check risk-evaluation system; receiving verification from the check verification system; and receiving risk-evaluation from the risk-evaluation system. The check may then be retained at the facility for later collection and submission to the issuing institution.

In those embodiments of the method in which the user intends to collect a money transfer, the establishment of the availability of funds comprises verifying that the user is the intended recipient of a money transfer.

Of course, funds may be made available from multiple sources. A user might remit cash and a money order during the same session. Accordingly, the method may comprise any combination of the various embodiments of establishing the availability of funds discussed above.

Payment may be transmitted in various ways. Payment may be transmitted to the user at the facility or to a third party. In some cases the method will comprise dispensing cash to the user at the facility from the cash dispenser.

Some embodiments of the method comprise transmitting payment by printing a money order at the facility; further embodiments comprise obtaining payee and amount information from the user. Payee and amount information may be obtained by any suitable means. For example, the remote moderator may verbally obtain the amount, payee, or both via the primary microphone at the facility. The information may be obtained via a touch-mediated user interface, such as a touch-screen or keypad. A voice-recognition system could also be used to obtain verbal information. If the money order requires the purchaser's signature, the method may further comprise obtaining the user's signature on the signature pad. If the user is unable to write, a signature equivalent may be obtained by various means known in the art. For example, a thumbprint could be obtained in conjunction with a verbal assent. As another example, an audiovisual record could be made of the dialog between the user and moderator in which the moderator explains the terms of the money order, and the user signals assent verbally. In a further example, the user may assent by touching a touch-screen object.

In some cases the method will comprise transmitting payment by issuing a pre-paid card at the facility. This may comprise writing a new card and issuing it to the user, or writing on the user's pre-existing card to increase the balance on the card.

In some cases the method will comprise transmitting payment by entering an order for a money transfer, for example via MoneyGram or Western Union. Information regarding the sender, the amount, and the recipient will be transmitted electronically to a money transfer organization's automated system. Information regarding the money transfer control number will then be received from the money transfer organization's automated system and given to the user. The money transfer control number may be provided verbally, via the speaker on the facility. It may also be provided on the video screen, or it may be printed on the facility's printer. The user may be given the option of how he or she would like to receive the money transfer control number. The facility may record any aspect or aspects of the transaction.

In some cases the method comprises transmitting payment by an electronic transfer of funds to a third party on behalf of the user. The third party will generally be a creditor. Examples of creditors with which the user of the facility may have an account include a utility company, an auto finance company, a healthcare company, a taxing authority, a governmental permitting agency (such as a motor vehicle agency), an insurance company, a residential landlord, a mortgage company, a cellular telephone carrier, or an interne service provider. The payment may be made, for example via online bill pay, via a wire transfer, or via an electronic funds transfer. Nearly all businesses and many governments are capable of receiving funds via online bill pay. Information about the creditor may be received from the user at the time the transaction is requested, or it may be retrieved from a computerized database, if the user has submitted the information previously. If the payment is a recurring payment of uniform amount, the amount to be transferred may also be retrieved from the computerized database. However, if the amount is not uniform, it will be obtained from the user at the time the transaction is requested (the user may simply specify “the balance,” in which case a balance inquiry may be sent to the creditor if such information is available electronically).

Of course, the user may specify that payment is to be transmitted in more than one form, so long as the total amount of payments transmitted does not exceed the funds established to be available. For example, the user may submit a $300 paycheck and request a $100 short term loan; the user may then request $50 in cash, a $50 money order made out to an individual, an increase in the balance of his pre-paid calling card by $100, and an online bill payment to a hospital of $200. This example assumes that no transaction fees are applied, for the sake of simplicity. In practice, there will generally be transaction fees applied for each type of transaction.

In a particular embodiment the method allows the user to convert a balance on a prepaid card to cash. In this embodiment the availability of funds is established by receiving funds on a prepaid card, and payment is transmitted to the user by dispensing cash.

In another particular embodiment the method allows the user to obtain a short term loan. This embodiment comprises receiving the image of the check by the remote moderator; retaining the check at the facility; printing a loan agreement at the facility; and receiving an image of a signed loan agreement.

Some embodiments of the method further comprise maintaining a full record of the user's encounter with the facility. An audiovisual recording device stores the teleconference on a computing device connected to a machine-readable storage device. Other forms of information related to the encounter may be stored, such as images of documents, identity information, communications with outside service providers, and the contents of documents printed at the facility. Such information may be stored in an audit database for later review.

Some embodiments of the method comprise maintaining a queue of users. The queue comprises a plurality of users present at the facility at a given time. As processes are initiated that do not require the attention of a given user currently using the facility, the next user in the queue will be summoned to the facility. If a previous user's attention is required, the previous user will be summoned to the facility. Depending on the type of financial instrument presented, there are significant delays for a non-depository user in verifying their eligibility to receive immediate funds. This is particularly true of checks. The queuing method described significantly lowers total wait times at the facility for users by allowing parallel processing of their transactions.

Users in the queue may be summoned by any means known in the art. In some embodiments of the method the user is summoned to the facility by displaying identifying information about the user (such as the user's name or an agreed upon object representing the user, as would be useful for a user of low literacy skills) on a queue display positioned to be visible in the general area of the facility. In some embodiments of the method the user is summoned to the facility by announcing identifying information about the user on a voice-quality broad-area speaker positioned to be comprehensible in the general area around the facility. In some embodiments where the user has a mobile device capable of text messaging, the user may be sent a short messaging service message to their mobile device, or the user may be called on a mobile phone when the queue requires it.

A specific embodiment of the method can be used for honoring a check having a payee at the facility, without reference to or requirement for a bank account of the payee, said method comprising: establishing a video conference between a user and a remote moderator; capturing an image of the user's face and transmitting the image to the remote moderator; reading identifying information from an identification document at the videoconferencing access facility and transmitting the identifying information to the remote moderator; comparing the image of the user's face to a stored image associated with the identifying information to confirm the user's identity; capturing an image of the check using a check scanner at the videoconference access facility and transmitting the image of the check to the remote moderator, wherein the check contains check information; transmitting the check information to a check verification system and receiving a verification response; transmitting the check information to a check risk evaluation system and receiving a risk response; making a determination of whether to honor the check based on at least one of the verification response and the risk response; providing payment to the user up to the value of the check in any combination of the following: making an electronic bill payment; writing value to a debit card at the videoconference access facility; writing value to a calling card at the facility; writing value to a gift card at the facility; dispensing cash at the facility; printing a money order at the facility; and making a money transfer; and saving transaction information to an audit database.

Some embodiments of the method comprise selecting a background image from a background image library that corresponds to the requested service; and compositing the background image with an image of the moderator during the videoconference. The background may correspond to the service provided to the user.

The method may further comprise determining a preferred language of the user; and establishing the videoconference with a remote moderator competent in said preferred language. The method may further comprise accessing a script corresponding to the service from a script library, to be displayed at either of the facility or the workstation. In further embodiments the script is in the preferred language of the user.

### D. Remote Moderator Workstation

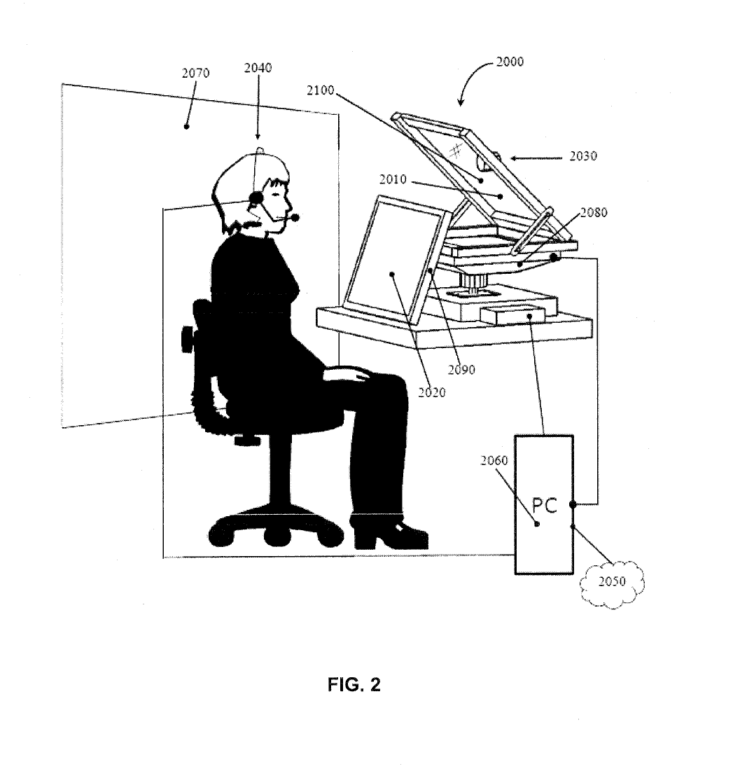

A workstation for a remote moderator is provided. One embodiment of the workstation is shown in FIG. 2. The remote moderator workstation is a computer comprising a user interface that allows the remote moderator to view the image of the user's face captured by the facility's primary camera, allows the remote moderator to understand the user's speech transmitted from the facility's primary microphone, allows the remote moderator to view captured images of financial instruments and other documents, allows the remote moderator to understand information provided by the user via other input devices (such as the touch-screen and the card reader), and allows the remote moderator to issue commands to the facility. In the context of this paragraph, the term “understand” indicates that the information is provided in a manner that can be perceived by the remote moderator or another observer (either contemporaneous or observing recorded information at a later time); this may include displaying text or images on the moderator's monitor, producing synthesized or transmitted speech, or printing a document at the moderator's location. In some embodiments, the user's speech captured by the primary microphone may be translated into text and displayed to the moderator. Of course, the user's speech may simply be reproduced by speakers at the moderator's location. Similarly, sound or visual cues may be provided to the moderator to signal any type of event or input.

The computer connected to the user interface may be a standalone unit, such as a desktop or laptop computer, comprising a processor, primary storage, secondary storage, and various peripherals as known in the art. The computer may be shared among multiple moderators, each moderator using a terminal connected to a single computing device (known as a “dumb terminal”). The moderator workstation is provided with software for sending and receiving information between the workstation and the facility. Such software may include virtual telephony software and teleconferencing software to communicate with the user. The software on the workstation may also include software to read captured images transmitted from the facility, to send commands to the facility, and to receive information from other devices on the facility such as the card reader, the card writer, and the cash dispenser. The workstation may also be provided with software for viewing user records from a user database. Such records will comprise identifying information about the user, such as the user's name, address, customer number, social security number, date-of-birth, identity document number (drivers' license number, passport number, USCIS number, etc.), an image of the user's face, other physiological data (for example, a thumbprint), membership status in the network, telephone number, employer, and services for which the user is pre-approved.

Some embodiments of the workstation comprise: a remote feed display that is transparent when viewed from the side opposite the moderator; a local data display area; a camera positioned on the side of the remote feed display opposite the moderator and positioned to capture an image of the moderator's face; a microphone positioned to capture the moderator's voice; a connection to a videoconference access facility via a telecommunications network; a connection to an audit server comprising an audit record; a connection to at least one of a database server and an applications server; and a computing device connected to the videoconference access facility and configured to send and receive data with the videoconference access facility.

The remote feed display area provides information that is obtained at the station. Examples of such information include an image of a face of the user of the videoconference access facility, an image of a check scanned at the facility, an image of a document taken at the facility, an image of the front of the videoconference access facility from a first angle, an image of the front of the videoconference access facility from a second angle, an image of a passport, an image of a driver's license, an image of at least one of the user's hands while the user operates the facility, and an image from a signature pad.

In some embodiments of the remote feed display area the display area is a reflective surface that reflects an image of a remote feed display device positioned to provide a remote feed display image on the reflective surface that is visible to the moderator in the correct orientation. The remote feed display device will be configured to display images and/or information in mirror-image if it is directly reflected to be visible to the moderator. Of course, if there is another intervening mirror, the remote feed display device need not display a mirror image, as is understood in the art.

The camera is positioned such that, when the moderator looks at the remote feed display, the moderator's gaze is at least approximately directed at the camera. This allows the moderator to view the remote feed display while appearing to maintain his or her attention on the videoconference.

The local data display area serves to display information that is not collected by the station. Such information includes information from an identity database server pertaining to the identity of the user. Such information may also include information from outside service providers and governmental entities. This category includes information about check validity and risk, information about credit history, vehicle registration information, and communications from outside service providers. In some embodiments of the workstation the local data display area is on the same display device as the remote feed display area. Such configurations have the advantage of requiring fewer display devices. They also have the advantage of allowing the moderator to view the information on the local data display without appearing to divert his or her attention from the teleconference.

In some embodiments of the workstation the local data display area is on a local data display device positioned immediately above or immediately below the remote feed display area such that the moderator can view both the local data display area and the remote feed display without significantly turning the moderator's head to the left or to the right.

Some embodiments of the workstation employ a chroma key system to provide different virtual backgrounds during the teleconference. Some embodiments of the workstation comprise a chroma key screen positioned on the side of the moderator opposite the camera. In such embodiments the computing device has access to one or more chroma key background images in machine-readable format. In further embodiments the background images are stored in machine-readable format in a background library, in which the background corresponds to specific services or groups of services. For example, if the user requests a money transfer, a background could be loaded from the background library with the logo of the outside money transfer company. Chroma key technology is well known in the art, and various known permutations and variants can be used with the workstation.

### E. Remote Services Telecommunication Network

The disclosure provides a remote services telecommunication network. The network comprises a plurality of computing systems and communications connections to provide non-bank mediated services. Specifically, the network comprises a videoconference access facility as described previously, a remote moderator workstation connected to the facility via a telecommunications connection, a database server configured to be accessed by the moderator workstation, the database server containing a database of user identity information, and a telecommunications link capable of exchanging data between the moderator workstation and an external service provider.

The videoconference access facility may be any described herein.

The telecommunications connections may be any type of connection that is capable of conveying data at sufficiently high speeds to carry out the methods described herein. For example, the telecommunications connection between the remote moderator workstation and the videoconference access facility must be at least capable of carrying real-time audio and video at sufficiently high quality to provide intelligible speech. In some embodiments the connection is capable of carrying synchronized audio and video. An example of a suitable telecommunications connection between the facility and the workstation is a T1 line. Others are known in the art and are not recited here. The telecommunication connections will comprise other structures, such as routers and junctions, as needed.

The workstation may be any that is described above. In some embodiments of the network the workstation is configured to transmit voice data in both directions, configured to transmit video data at least from the facility to the moderator, and configured to transmit instructions from the moderator workstation to a computing device in the facility.

The telecommunications link to the outside service provider may be a link to an external service provider is selected from the group consisting of: a remote deposit capture system, a check verification system, an electronic bill-pay system, a payment transfer system, an online banking system, a credit evaluation system, and a loan evaluation system, a motor vehicle regulating agency, an accounting system of a creditor, and an accounting system of a utility.

Some embodiments of the network comprise a means for monitoring the net capacity of a group of moderators with regard to a group of facilities. The group may comprise all of the moderators or all of the facilities; the group may also comprise a certain fraction thereof. Additionally, the network may comprise a means for directing requests for services at the facilities to moderators best able to assist the user, based on capacity, expertise, equipment and software available to the moderator, or other factors. In addition, there may be means present to allow a user to be transferred from a moderator to another staff member of particular skills (including language skills) or seniority.

User information will be stored in one or more computerized databases on one or more user database file servers. The workstation is connected to the user database file server via a suitable telecommunication connection. Additional software will run on computers that are either connected to the user database file server and the workstation via a suitable telecommunication connection, or running on the same computer that is the user database file server or the remote moderator workstation. The additional software may include accounting software that records transactions performed for the user and stores data regarding the transactions; the data can then be viewed as a financial statement. The accounting software may be capable of tracking the membership account of each member, and transmitting it to the remote moderator upon request.

The workstation may be connected, directly or indirectly, to other computerized financial systems (as may the user database file server). For example, the workstation may be connected to the computerized check capture system (such as that maintained by CPI), such that check images captured by the facility can be transmitted to the computerized check capture system for deposit. Such a connection would be configured to allow communications from the computerized check capture system to the workstation, for example to inform the moderator of a verification error.

As another example, the workstation may be connected to a computerized verification system, such as the one maintained by Chexar, such that check images captured by the facility can be transmitted to the computerized verification system for acceptance or rejection.

Either or both of the workstation and the user database server may be connected to one or more computerized bill pay systems, computerized money transfer systems, electronic tax and governmental fee systems, an online banking system, a computerized system for sending electronic fund transfers, and a computerized system for sending wire transfers. The system may further comprise software running on any of the computing devices (or additional computing devices) capable of translating a request by the user or the moderator for a financial transaction, and any accompanying data (such as scanned check images and identification information) into a format compatible with the outside computerized system.

Any of the workstation, the facility, and the user database server may be connected to a public services management system. Such systems will comprise automated and human-implemented means of providing public services based on documents, identification, and payment processed at the facility.

The network may further comprise an audit database. The audit database comprises a plurality of records containing audiovisual records of user encounters with one or more videoconference access facilities. The records may contain additional information collected by the facility, obtained by the workstation, or received by the moderator, as described elsewhere in this disclosure. Some embodiments of the network comprise an audiovisual recording device, such as a DVR, configured to record input from the various cameras and microphones in the network. The stored information may then be reviewed for auditing purposes or uploaded for storage purposes. The audiovisual information may be combined with other data from the transaction to generate a transaction record or an encounter record.

Some embodiments of the network comprise a queue file in machine-readable format comprising a user queue. The user queue may be read by the moderator to manage user flow at a facility, as described elsewhere in this disclosure.

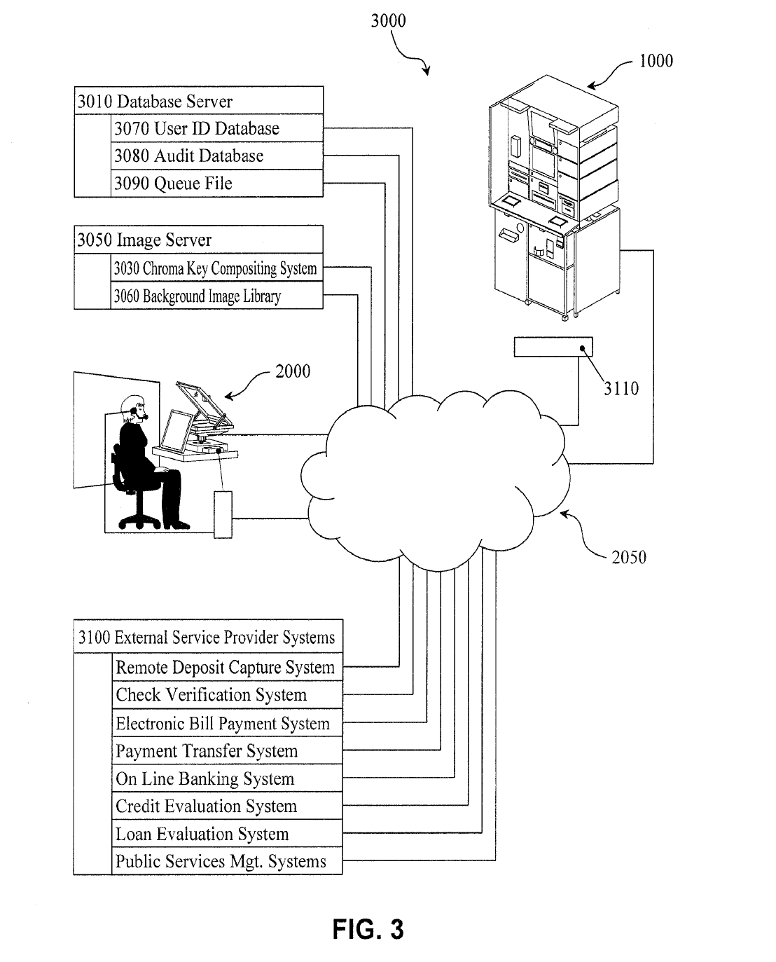

An embodiment of the network is shown in FIG. 3.

### F. Examples

A prophetic example is provided of an unbanked user cashing a check, who is not a native speaker of the official language of her country of residence and is functionally illiterate. The user approaches a videoconference access facility; the station displays the message “press here to call a teller” on the data display area touch-screen. However, the user cannot read the message, and so she picks up the microphone/speaker handset. This initiates a teleconference with a moderator. The moderator's workstation remote feed display shows a message “incoming call.” As the moderator is not busy, she answers the call.

A video feed of the moderator's face appears on the videoconference display area of the facility. A script appears on the moderator' remote feed display. The remote feed display is split into four quarters. The bottom right quarter shows video feed of the user's face from the facility. The bottom left quarter displays the text of a script the moderator follows in interacting with the user. The top left quarter displays connection status information (connected, offline, mute, etc.) The top right quarter displays the feed from a monitor camera showing the peripheral devices at the front of the facility, specifically the cash dispenser, the signature pad, the driver's license scanner, and the check scanner.

A script appears in the remote feed display, reading “1. Greet customer and smile. 2. “Can I help you.” 3. Give your name. 4. Enter response.” Following the script, the moderator greets the user in the local official language. The user responds in her native language. The moderator switches to the user's native language and continues with the script (if the moderator had low fluency in the user's native language, the call would be transferred to a moderator with the appropriate language skills). The moderator's local data display area shows a list of menu items corresponding to services that can be provided.

The user verbally asks to cash a check. The moderator selects the “cash check” service from the list of menu items on the moderator's local data display area. A new script is loaded and displayed on the moderator's remote feed display area. The script reads “1. ‘May I have your name and address please?’ 2. Input data. 3. Press continue.” The moderator reads the script and asks for the user's name and address; the user responds, and the moderator enters the information into the user identity information database. The moderator then presses the “continue” icon on the local data display area.

A new script is loaded and displayed on the remote feed display area, reading “1. ‘Please place your driver's license on the scanner.’ 2. If user cannot find scanner, direct them to the blue flashing light.” The moderator reads the script. A blue LED is activated on the driver's license scanner. The user places her driver's license on the scanner. The moderator watches her do so on the upper right corner of the remote feed display. The scanner captures an image of the driver's license, which is transmitted to the moderator's workstation and appears on the local data display area. The user's name, address, facial image, and driver's license image are then saved to the user identification database.

A new script is loaded and displayed to the moderator, reading “1. ‘Please put your check through the scanner.’ 2. If user cannot find scanner, direct them to the blue flashing light.” A blue LED is activated on the check scanner. The moderator reads the script and asks the users to run the check through the scanner. The user does so, and the scanned image of the check is received by the workstation and displayed on the moderator's local data display area. The moderator asks the user to wait. The moderator transmits the image of the check to a check validating system and a remote deposit system. Assuming the check is valid, it is then deposited via remote deposit.

The user then specifies how the balance of the check (minus any service fee) will be allocated. In this example, the check is for $200, and there is a $5 service fee. The user requests the moderator pay $50 to her electrical utility, print a money order payable to John Doe for $50, add $50 in value to her calling card, and pay the remaining balance ($45) in cash. The moderator loads a script for each. The moderator connects to the electrical utility's internal accounting system and effects payment. The moderator obtains the payee and amount of the money order verbally from the user and transmits instructions to the facility to print the money order. The moderator guides the user through the process of inserting her calling card into the card writer, and instructs the card writer to add $50 to the card. The moderator is able to review the user's hands and the card writer via the monitor camera, in case the user should misuse the reader or need guidance. If the user requests no further services, the call is terminated.

### G. Conclusions

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein.

1-13. (canceled)

14. A method of transmitting payment on behalf of a user of a videoconference access facility without a requirement for, or reference to the user's bank account, comprising:
(a) establishing the identity of the user by a process comprising:
(i) receiving from the user a code corresponding to a money transfer, or capturing an image of the user's face with a camera and transmitting the image to a remote moderator; and
(ii) receiving identifying information with an identity document reader to corroborate the user's identity, and transmitting the identifying information to the remote moderator;
(b) establishing the availability of funds; and
(c) transmitting payment to the user or a third party.

15. The method of claim 14 wherein the availability of the funds is established by a process selected from the group consisting of:
(a) issuing credit to the user based on the identity of the user and credit information pertaining to the user;
(b) receiving cash at the videoconference access facility that is authenticated automatically at the facility;
(c) receiving funds on a prepaid card;
(d) verifying that the user is the recipient of a money transfer; and
(e) receiving a paper financial instrument at the facility and transmitting an image of the paper financial instrument from the facility to a verifier.

16. The method of claim 14, wherein the availability of funds is established by receiving a paper financial instrument that is a check, the method further comprising:
(a) receiving the image of the check by the remote moderator;
(b) transmitting the check information to a check verification system;
(c) transmitting the check information to a check risk-evaluation system;
(d) receiving verification from the check verification system; and
(e) receiving risk-evaluation from the risk-evaluation system.

17. The method of claim 14, wherein payment is transmitted by a process selected from the group consisting of:
(a) dispensing cash to the user from a cash dispenser at the facility;
(b) printing a money order at the facility;
(c) issuing a pre-paid card to the user from a card-writer at the facility;
(d) writing value to a pre-paid card from a card-writer at the facility;
(e) requesting a money transfer; and
(f) transmitting electronic payment to a third party on behalf of the user.

18. The method of claim 14, wherein the availability of funds is established by receiving funds on a prepaid card, and wherein payment is transmitted to the user by dispensing cash.

19. The method of claim 14, wherein the availability of funds is established by receiving a paper financial instrument that is a check, the method further comprising:
(a) receiving the image of the check by the remote moderator;
(b) retaining the check at the facility;
(c) printing a loan agreement at the facility; and
(d) receiving an image of a signed loan agreement.

20. The method of claim 14, comprising recording information collected by the facility in an audit database.

21. The method of claim 14, comprising compiling a queue of a plurality of users and announcing the current user in the queue, wherein the announcement is made by at least one of: displaying information specific to the current user on a queue display positioned to be visible in the general area around the facility, and calling the current user on a voice-quality queue speaker positioned to be comprehensible in the general area around the facility.

22. A method of honoring a check having a payee at a videoconferencing facility, without reference to or requirement for a bank account of the payee, said method comprising:
(a) establishing a video conference between a user and a remote moderator;
(b) capturing an image of the user's face and transmitting the image to the remote moderator;
(c) reading identifying information from an identification document at the videoconferencing facility and transmitting the identifying information to the remote moderator;
(d) comparing the image of the user's face to a stored image associated with the identifying information to confirm the user's identity;
(e) capturing an image of the check using a check scanner at the videoconference access facility and transmitting the image of the check to the remote moderator, wherein the check contains check information;
(f) transmitting the check information to a check verification system and receiving a verification response;
(g) transmitting the check information to a check risk evaluation system and receiving a risk response;
(h) making a determination of whether to honor the check based on at least one of the verification response and the risk response;
(i) providing payment to the user up to the value of the check in any combination of the following: making an electronic bill payment; writing value to a debit card at the videoconference access facility; writing value to a calling card at the videoconference access facility; writing value to a gift card at the videoconference access facility; dispensing cash at the videoconference access facility; printing a money order at the videoconference access facility; and making a money transfer; and
(j) saving transaction information to an audit database.

23-36. (canceled)

37. A method of providing a verbally-mediated service to a user from a plurality of available services via a videoconference, without reference to or requirement for a bank account of the user, comprising:
(a) establishing a videoconference with the user of a videoconference access facility via a telecommunications network;
(b) receiving a request for the service from the user via the facility;
(c) receiving identifying information from the user via the facility, said identifying information comprising an image of the user's face captured by the facility;
(d) transmitting the user's identity to a service-provider computing system;
(e) receiving service-related content from the service-provider computing system; and
(f) transmitting the service-related content to the user over the network.

38. The method of claim 37, further comprising accessing a service-provider interface module from an interface module library, said interface module library comprising a plurality of service-provider interface modules, wherein the service-provider interface module enables direct communication to the service-provider computing system.

39. The method of claim 37 comprising:
(a) establishing the availability of funds to the user; and
(b) transmitting an indication to the service-provider computing system that payment has been received by the user.

40. The method of claim 37, wherein the service-provider is a governmental benefits provider, and further comprising:
(a) receiving a request from the user to receive a governmental benefit;
(b) receiving eligibility information from the user; and
(c) transmitting the request and the eligibility information to the service-provider computing system.

41. The method of claim 37 comprising selecting a background image from a background image library that corresponds to the requested service; and compositing the background image with an image of the moderator during the videoconference.

42. The method of claim 37, further comprising determining a preferred language of the user; and establishing the videoconference with a remote moderator competent in said preferred language.

43. The method of claim 37, comprising accessing a script corresponding to the service from a script library.

44. The method of claim 43, comprising determining a preferred language of the user; and wherein the script is in the preferred language.

45. The method of claim 37, wherein the facility is the videoconference access facility of claim 6.

46. The method of claim 37, comprising establishing the videoconference between the facility and a workstation for a remote moderator comprising: (a) a remote feed display area that is transparent when viewed from the side opposite the moderator; (b) a local data display area; (c) a workstation camera positioned on the side of the remote feed display opposite the moderator and positioned to capture an image of the moderator's face; (d) a workstation microphone positioned to capture the moderator's voice; (e) a connection to a videoconference access facility via a telecommunications network; (f) a connection to at least one of a database server and an applications server; and (g) a computing device connected to the videoconference access facility and configured to send and receive data with the videoconferencing facility.

47. The method of claim 37, wherein the identifying information is in part received from an identity document reader to corroborate the user's identity.

48. The method of claim 47, wherein the identity document is an ID card, and wherein the identity document reader is a magstripe reader.

49. The method of claim 47, wherein:
(a) the identity document is selected from the group consisting of: an ID card, an entitlement benefit card, a birth certificate, a passport, a vehicle title, and a driver's license; and
(b) the identity document reader is selected from the group consisting of: a magstripe reader, a smart card reader, an RFID reader, a document scanner, a passport scanner, a driver's license scanner, a drawer-mounted document viewer, and a combined passport/driver's license validation device.

50. The method of claim 37, wherein the service is selected from the group consisting of: an educational presentation, an electronic bill payment, honoring a check, honoring a money order, obtaining a loan, purchasing a calling card, satisfying a fine, registering a vehicle, applying for or renewing a license, requesting a public benefit, and executing a money transfer.

51. The method of claim 37 comprising recording transaction information to an audit database.

52. The method of claim 37, comprising compiling a queue of a plurality of users and instructing the facility to announce the current user in the queue.

53. A method of providing a verbally-mediated service to a user from a plurality of available services via a videoconference, without reference to a bank account of said user, comprising:
(a) establishing a videoconference with a remote moderator from a videoconference access facility via a telecommunications network;
(b) transmitting a request for the service from the user via the facility;
(c) transmitting identifying information from the user via the facility to the remote moderator, said identifying information comprising an image of the user's face captured by the facility; and
(d) receiving service-related content from the remote moderator and providing the content to the user.

54. The method of claim 53, wherein the service-provider is a governmental benefits provider, and further comprising:
(a) transmitting a request from the user to receive a governmental benefit; and
(b) transmitting eligibility information from the user.

55. The method of claim 53, wherein the videoconference displays a moderator and a background, wherein a background image from a background image library that corresponds to the requested service is composited with an image of the moderator during the videoconference.

56. The method of claim 53, further comprising transmitting a preferred language selected by the user; and establishing the videoconference with a remote moderator competent in said preferred language.

57. The method of claim 53, wherein the facility is a videoconference access facility comprising: a communications interface linking the facility to a remote moderator over a telecommunications network; a videoconference display area; a data display area; a primary camera positioned to capture an image of the user's face; a primary microphone capable of capturing voice-quality sound; a primary speaker capable of producing voice-quality sound; a plurality of secure enclosures extending to the front of the facility capable of interchangeably containing a peripheral device, and comprising an interchangeable front panel to provide partial access to the peripheral device by the user; (h) an identity reader configured to transmit identity data to a remote moderator, located in one of the said enclosures, the identity reader selected from the group consisting of: an identity card reader, a signature pad, a fingerprint reader, a barcode scanner, a drawer-mounted document viewer, and a document scanner; and (i) a computing device connected to the communications interface and configured to exchange data with the videoconference display area, the data display area, the primary camera, the primary microphone, the primary speaker, and the identity reader.

58. The method of claim 53, comprising establishing the videoconference between the facility and a workstation for a remote moderator comprising: (a) a remote feed display area that is transparent when viewed from the side opposite the moderator; (b) a local data display area; (c) a workstation camera positioned on the side of the remote feed display opposite the moderator and positioned to capture an image of the moderator's face; (d) a workstation microphone positioned to capture the moderator's voice; (e) a connection to a videoconference access facility via a telecommunications network; (f) a connection to at least one of a database server and an applications server; and (g) a computing device connected to the videoconference access facility and configured to send and receive data with the videoconferencing facility.

59. The method of claim 53, wherein the identifying information is in part received from an identity document reader to corroborate the user's identity.

60. The method of claim 59, wherein the identity document is an ID card, and wherein the identity document reader is a magstripe reader.

61. The method of claim 59, wherein:
(a) the identity document is selected from the group consisting of: an ID card, an entitlement benefit card, a birth certificate, a passport, a vehicle title, and a driver's license; and
(b) the identity document reader is selected from the group consisting of: a magstripe reader, a smart card reader, an RFID reader, a document scanner, a passport scanner, a driver's license scanner, a drawer-mounted viewer, and a combined passport/driver's license validation device.

62. The method of claim 53, wherein the service is selected from the group consisting of: an educational presentation, an electronic bill payment, honoring a check, honoring a money order, obtaining a loan, purchasing a calling card, satisfying a fine, registering a vehicle, applying for or renewing a license, requesting a public benefit, and executing a money transfer.

63. The method of claim 53 comprising recording transaction information to an audit database.

64. The method of claim 53, comprising compiling a queue of a plurality of users and announcing the current user in the queue, wherein the announcement is made by at least one of: displaying information specific to the current user on a display positioned to be visible in the general area around the facility, and calling the current user on a voice-quality speaker positioned to be comprehensible in the general area around the facility.
